(19) United States
(12) Patent Application Publication
(10) Pub. No.: US 2010/0226601 A1
(43) Pub. Date: Sep. 9, 2010

(54) FLUID DYNAMIC BEARING DEVICE

(75) Inventors: Yoshiharu Inazuka, Aichi (JP); Jun Hirade, Kuwana-shi (JP); Tetsuya Kurimura, Kuwana-shi (JP); Isao Komori, Kuwana-shi (JP); Kimihiko Bitou, Aichi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NTN CORPORATION, Osaka-shi, Osaka (JP)

(21) Appl. No.: 12/377,293

(22) PCT Filed: Aug. 28, 2007
(86) PCT No.: PCT/JP2007/066601

§ 371 Date: Feb. 12, 2009

(30) Foreign Application Priority Data
Sep. 12, 2006 (JP) 2006-247114
Sep. 13, 2006 (JP) 2006-248164
Sep. 19, 2006 (JP) 2006-252918
Oct. 31, 2006 (JP) 2006-296182
Nov. 24, 2006 (JP) 2006-317342
Dec. 8, 2006 (JP) 2006-332130

(51) Int. Cl. F16C 32/06

(52) U.S. Cl. 384/107

(57) ABSTRACT

A hub (10) is a product formed by injection molding of a resin together with a core metal (13) as an inserted component, and the core metal (13) is exposed on a surface of the hub (10). With this configuration, a cavity of a die for molding the hub (10) is not divided by the core metal (13), and hence it is possible to suppress deterioration in fluidity of a resin due to arrangement of the core metal (13) in the cavity.

### TECHNICAL FIELD

The present invention relates to a fluid dynamic bearing device for rotatably supporting a shaft member by means of a lubricating film generated in bearing gaps.

### BACKGROUND ART

The fluid dynamic bearing device of this type is suitably applicable to a spindle motor for an information apparatus including a magnetic disk drive like an HDD, an optical disk drive for a CD-ROM, CD-R/RW, DVD-ROM/RAM, or the like, or a magneto-optical disk drive for an MD, MO, or the like, or to a polygon scanner motor of a laser beam printer (LBP), a motor for a projector color wheel, or a small motor such as a fan motor used in a cooling fan of an electrical apparatus or the like.

For example, FIG. 5 of Patent Document 1 illustrates the fluid dynamic bearing device including the shaft member, and the hub (disk hub) made of a resin, which protrudes in a radially outward direction with respect to the shaft member, in which a core metal (metal portion) is embedded inside the hub. As described above, the hub made of a resin includes the core metal, whereby the strength of the hub can be increased. As a result, it is possible to prevent deformation of the hub due to a clamping force and the like at the time of disk mounting.

Further, the fluid dynamic bearing device illustrated in FIG. 6 of Patent Document 1 includes the shaft member, the flange portion provided at the one end of the shaft member, the flange-like hub (disk hub) provided at the another end of the shaft member, the bearing sleeve having the shaft member inserted along the inner periphery thereof, and the housing for holding the bearing sleeve. When the shaft member is rotated, the one thrust bearing gap is formed between the end surface of the hub and the end surface of the housing, and the another thrust bearing gap is formed between the end surface of the flange portion and the end surface of the bearing sleeve. Owing to the dynamic pressure effect of the lubricating oil generated in those thrust bearing gaps, the shaft member is supported in both the thrust directions.

Still further, FIG. 2 of Patent Document 1 illustrates the fluid dynamic bearing device in which the shaft member is not provided with the flange portion, and the thrust bearing gap is formed at only one portion.

Patent Document 1: JP 2005-337342 A

### DISCLOSURE OF THE INVENTION

### Problems to Be Solved By the Invention

The hub as described above can be formed by injection molding of a resin together with, for example, the shaft member and the core metal as inserted components. FIG. 9 illustrates an example of a molding die for forming the hub as described above. The die is constituted by a fixed die 103 and a movable die 104, and a shaft member 101 which fixes a core metal 102 is inserted into a fixation hole 105 provided at the axial center of the movable die 104. A cavity 106 is formed by clamping the die as described above, and a molten resin is injected into the cavity 106 via a gate 107 provided near the radially outer end of the molding surface of the movable die 104.

In the cavity 106, the core metal as an inserted component is arranged. With this configuration, the flow path of the molten resin injected in the cavity is narrowed, and hence the fluidity of the molten resin is deteriorated. Further, when the core metal 102 is embedded inside the hub as described above, the core metal 102 is arranged at the central portion of the cavity 106, that is, at a position free from being brought into contact with the die. With this configuration, the cavity 106 is divided into a outer side region 106a and a inner side region 106b with respect to the core metal 102, and hence the flow path area of the molten resin in each of the regions is further narrowed. Thus, there is a risk that the fluidity of the molten resin is further deteriorated so that the resin is not filled to the end portion of the cavity 106. When the resin is insufficiently filled, the dimensional accuracy necessary for the hub cannot be obtained. In particular, when the resin is insufficiently filled in the boundary surface with respect to the shaft member 101, there is a risk that a gap is formed between the resin molding portion and the shaft member 101, the fixation force therebetween is decreased, and the lubricant filled inside the bearing leaks out from the gap.

In order to enhance the fluidity of the molten resin in the cavity 106 having the core metal 102 arranged therein, for example, it suffices that the core metal 102 is thinned for securing the flow path area of the molten resin. However, when the core metal 102 is thinned, there is a risk that the rigidity of the core metal 102 is deteriorated, and the strength necessary for the hub cannot be obtained.

Further, there is a risk that the core metal 102 embedded in the hub causes the following failures. FIG. 10 is a partially enlarged view of a fluid dynamic bearing device including a hub 109 formed as described above. In the fluid dynamic bearing device, as illustrated in FIG. 10, in the hub 109, an end portion on the inner bearing side of the boundary surface with respect to the shaft member 2 is formed of a resin portion 108, and hence there is a risk that the shear drop occurs in a resin of this portion (indicated by P in FIG. 10). As described above, when the shear drop to the inner bearing side occurs at the radially inner end of the hub 109, there is a risk that the fluidity of the lubricant is deteriorated, and the resin portion 108 interferes with a bearing sleeve 110 opposed thereto in a case of the large shear drop.

Further, positioning accuracy of the hub in the axial direction with respect to the shaft member is an important factor in the bearing device as described above. For example, in the fluid dynamic bearing device illustrated in FIG. 6 of Patent Document 1 described above, an axial distance between the end surface of the hub, which is faced with the one thrust bearing gap, and the end surface of the flange portion, which is faced with the another thrust bearing gap, has direct influence on the width accuracy of the thrust bearing gaps. Thus, when the hub is not positioned with respect to the shaft member in the axial direction with high accuracy, the width accuracy of the thrust bearing gap is lowered, with the result that the supporting force in the thrust direction is decreased.

Further, in the fluid dynamic bearing device illustrated in FIG. 2 of Patent Document 1 described above, the positioning accuracy of the hub in the axial direction with respect to the shaft member is reflected to the axial distance between the lower end surface of the shaft member and the inner bottom surface of the housing. When the axial distance therebetween is excessively small, there is a risk of increase in torque at the time of rotation of the shaft member. Meanwhile, when the axial distance therebetween is excessively large, the space inside the bearing is increased, and the amount of lubricating oil to be filled is increased. Therefore, it is necessary to increase the volume of a seal space for absorbing change in volume in accordance with change in temperature of the lubricating oil, which leads to increase in size of the bearing device.

Further, in the fluid dynamic bearing device illustrated in FIG. 5 of Patent Document 1 described above, the shaft member is formed in a shape of stepped shaft so as to have a shoulder surface. By being brought into contact with the shoulder surface, the core metal is positioned with respect to the shaft member in the axial direction. However, the core metal is covered with the resin portion, and hence even when the core metal is positioned with high accuracy, the accuracy of the end surface of the hub is decreased owing to molding shrinkage of a resin, which leads to a risk that a desired width accuracy of the thrust bearing gap and the like cannot be obtained.

It is therefore an object of the present invention to enhance, in the fluid dynamic bearing device provided with the hub made of a resin, which has the core metal, the moldability thereof while maintaining the strength of the hub, and to prevent deterioration in fluidity of the lubricant filled inside the bearing.

Further, another object of the present invention is to enhance, in the fluid dynamic bearing device provided with the hub which has the core metal, bearing performance by positioning the end surface of the hub, which forms the thrust bearing gap, with high accuracy with respect to the shaft member in the axial direction.

### Means for solving the Problems

In order to achieve the above-mentioned objects, the present invention provides a fluid dynamic bearing device, including:

a shaft member;

a hub protruding in a radially outward direction with respect to the shaft member and attached with a rotor magnet;

a radial bearing gap faced with an outer peripheral surface of the shaft member; and

a thrust bearing gap faced with an end surface of the hub, the shaft member being supported by a lubricating film generated in the radial bearing gap and the thrust bearing gap,

characterized in that the hub is a product formed by injection molding of a resin together with a core metal inserted thereto, the core metal being exposed on a surface of the hub.

As described above, in the present invention, the hub is formed by injection molding of a resin together with the core metal inserted thereto, and the core metal is exposed on the surface of the hub. With this configuration, the core metal can be provided in contact with any of the dies in the cavity, and hence the cavity is not divided by the core metal. Accordingly, it is possible to suppress the deterioration in fluidity of a resin, which is caused by arrangement of the core metal in the cavity.

When the portion of the hub, which is faced with the space filled with the lubricant, is formed of the core metal, the resin portion is free from contact with the lubricant. Thus, it is unnecessary that the resin material have resistance to the lubricant, and hence the degree of freedom in selecting the resin material is increased. Further, with this structure, an end portion of the radially inner end of the hub on the inner bearing side is formed of the core metal, and hence the shear drop of the resin portion does not occur in this portion. As a result, it is possible to prevent the failure caused thereby.

In the fluid dynamic bearing device, normally, there is provided a seal space for preventing lubricant from leaking out. In the seal space, an outer peripheral surface of the seal space is constituted by a tapered surface having an undercut shape in some cases, the tapered surface being formed on an inner peripheral surface of the hub. When the tapered surface provided to the hub, which has the undercut shape, is made of a resin, the molded product is forcibly pulled at the time of demolding thereof, which leads to the risk of damaging the tapered surface. In the present invention, the tapered surface is formed of the core metal, whereby it is unnecessary to form the die configuration corresponding to this portion in conformity with the tapered surface. Accordingly, for example, the die corresponding to this portion is formed to have a cylindrical surface, whereby it is possible to avoid the interference between the tapered surface and the die, and to prevent damage on the tapered surface, which is caused by forcible pulling.

To the hub made of a resin as described above, a metal yoke for preventing magnetic flux leakage of the rotor magnet is attached in many cases. When the metal yoke as described above is bonded to be fixed to the resin portion, owing to weak fixation force in bonding a resin and a metal to each other, there is a risk that the sufficient fixation strength cannot be obtained. In view of this, when the yoke is directly bonded to be fixed to the core metal exposed from the hub, it is possible to increase the fixation strength between the hub and the yoke. Alternatively, it is possible to form the core metal and the yoke integrally with each other in advance, and to form the hub together with the integrated product as an inserted component.

Further, in order to solve the above-mentioned problems, the present invention provides a fluid dynamic bearing device including a shaft member formed in a shape of stepped shaft so as to have a shoulder surface, a core metal engaged along the outer peripheral surface of the shaft member, a flange-like hub formed by injection molding together with the core metal inserted thereto, a radial bearing gap faced with the outer peripheral surface of the shaft member, a radial bearing portion for supporting the shaft member in a radial direction by the dynamic pressure effect of the lubricating film generated in the radial bearing gap, a thrust bearing gap faced with the end surface of the hub, and a thrust bearing portion for supporting the shaft member in a thrust direction by the dynamic pressure effect of the lubricating film generated in the thrust bearing gap, in which the end surface of the core member is brought into contact with the shoulder surface of the shaft member, and the thrust bearing gap is formed by the end surface of the core metal.

As described above, in the fluid dynamic bearing device of the present invention, the thrust bearing gap is formed by the end surface of the core metal, and hence, unlike the conventional products in which the core metal is covered with a resin, the accuracy of the end surface is not decreased owing to molding shrinkage. Accordingly, the end surface of the core metal is brought into contact with the shoulder surface of the shaft member so as to be positioned with respect to the shaft member with high accuracy in the axial direction, whereby it is possible to enhance the width accuracy of the thrust bearing gap, reduce the rotational torque, or downsize the bearing device.

Further, when the region of the outer peripheral surface of the shaft member, which is brought into contact with the hub, is provided with a concave-convex portion, owing to the anchor effect exerted by intrusion of an injection molding material of the hub into the concave-convex portion, the adhesion between the injection molding material and the outer peripheral surface of the shaft member is enhanced. As a result, the fixation strength between the hub and the shaft member is increased.

Further, when the shoulder surface of the shaft member is processed with high precision by grinding, it is possible to further increase the positioning accuracy of the core metal with respect to the shaft member. It is preferable that grinding of the shoulder surface be performed with reference to one end surface of the shaft member. For example, when positioning is effected by bringing the flange portion which forms the thrust bearing gap into contact with the end surface (FIG. 12), it is possible to set with higher accuracy an axial distance L between the end surface of the core metal, which forms one thrust bearing gap, and the end surface of the flange portion, which forms another thrust bearing gap. As a result, the widths of the thrust bearing gaps can be set with higher accuracy.

Further, of the shaft member, when the outer peripheral surface and the shoulder surface which are faced with the radial bearing gap are simultaneously grinded, it is possible to reduce the number of processes, and to set the perpendicularity and the fluctuation accuracy between those surfaces with high accuracy and with use of the grinding jig worked with high accuracy. Accordingly, the perpendicularity and the fluctuation accuracy are set with high accuracy between the radial bearing gap formed by the outer peripheral surface and the thrust bearing gap formed by the core metal brought into contact with the shoulder surface. As a result, the supporting force is increased in accordance with increase in width accuracy of the bearing gap, and the rotational accuracy of the bearing device is enhanced.

Incidentally, in the fluid dynamic bearing device of Patent Document 1, in order to avoid contact between the bearing sleeve and the hub, the end surface of the bearing sleeve is arranged on the inner bearing side in the axial direction with respect to the end surface of the housing. Thus, at the time of low-speed rotation, such as activation and stop of the bearing device, in which the dynamic pressure effect of the lubricating oil in the thrust bearing gap is not sufficiently exerted, the end surface of the hub and the end surface of the housing, which are opposed to each other through an intermediation of the thrust bearing gap, are brought into sliding contact with each other. When the surfaces opposed to each other through an intermediation of the thrust bearing gap are abraded as a result of the sliding contact, there is a risk that the accuracy of the gap width of the thrust bearing gap is decreased, and the supporting force in the thrust direction is lowered. In particular, when the dynamic pressure generating portions formed in those surfaces are abraded, there is a risk that the rotational accuracy and the supporting force in the thrust direction are largely decreased.

It is therefore an object of the present invention to provide a fluid dynamic bearing device capable of avoiding the sliding contact between the surfaces opposed to each other through an intermediation of the thrust bearing gap, and maintaining stable rotational accuracy and supporting force in the thrust direction by preventing the abrasion of those surfaces.

In order to achieve the above-mentioned object, the present invention provides a fluid dynamic bearing device including a rotary-side member and a fixed-side member, the rotary-side member being supported in the thrust direction by the dynamic pressure effect of the lubricating oil, which is generated in the thrust bearing gap between the rotary-side member and the fixed-side member, characterized in that a minute gap in the thrust direction, which is smaller in width than the thrust bearing gap, is formed between the rotary-side member and the fixed-side member.

As described above, in the fluid dynamic bearing device of the present invention, the minute gap in the thrust direction, which is smaller in width than the thrust bearing gap, is formed between the rotary-side member and the fixed-side member. For example, at the time of low-speed rotation, such as activation and stop of the bearing device, the surfaces opposed to each other through an intermediation of the minute gap are brought into contact with each other, whereby the contact between the surfaces opposed to each other through an intermediation of the thrust bearing gap is prevented. As a result, it is possible to suppress abrasion of the portions of the rotary-side member and the fixed-side member, which are faced with the thrust bearing gap, and hence it is possible to maintain the rotational accuracy and the supporting force in the thrust direction.

It is preferable that the minute gap be provided on the radially inner side of the thrust bearing gap. With this configuration, it is possible to suppress the circumferential velocity between the surfaces opposed to each other through an intermediation of the minute gap, that is, between the surfaces brought into sliding contact with each other at the time of low-speed rotation of the bearing device. Therefore, the abrasion caused by the sliding contact between those surfaces can be further suppressed.

When any one of the surfaces opposed to each other through an intermediation of the minute gap is made of an oil-impregnated material, the lubricating oil is constantly supplied to the minute gap, and hence the abrasion caused by the sliding contact therebetween can be further suppressed.

For example, one of the rotary-side member and the fixed-side member can be provided with the shaft member, and the hub protruding in a radially outward direction with respect to the shaft member, and the other of the rotary-side member and the fixed-side member can be provided with the bearing sleeve having the shaft member inserted along the inner periphery thereof, and the housing for holding the bearing sleeve along the inner periphery thereof. When a part of the end surface of the bearing sleeve is caused to protrude so that the above-mentioned minute gap is formed between the protruding portion and the hub, the area of the portion subjected to sliding contact is reduced when compared with the case where the entire of the end surface of the bearing surface is subjected to sliding contact. Therefore, rotational torque can be reduced. Alternatively, also when a part of the end surface of the hub is caused to protrude so that the above-mentioned minute gap is formed between the protruding portion and a part of a region of the end surface of the bearing sleeve, the same effect can be obtained.

Further, in the fluid dynamic bearing device as disclosed in Patent Document 1, the sealing device which absorbs thermal expansion of the lubricating oil filled therein and prevents the lubricating oil from leaking out. As described above, when the end surface of the bearing sleeve is arranged on the inner bearing side with respect to the end surface of the housing in the axial direction, there is formed a space of a relatively large volume between the disk hub and the bearing sleeve. When the space inside the bearing is filled with the lubricating oil, this space is also filled with the lubricating oil. As a result, the total amount of the lubricating oil is increased, and the thermal expansion amount of the lubricating oil is increased in accordance therewith. Accordingly, it is necessary to increase the size of the sealing device, which leads to increase in the size of the bearing device.

It is therefore an object of the present invention to reduce the total amount of the lubricating oil filled inside the fluid dynamic bearing device so as to downsize the bearing device.

In order to achieve the above-mentioned object, the present invention provides a fluid dynamic bearing device including a shaft member, and a hub protruding in a radially outward direction with respect to the shaft member, the shaft member and the hub being supported in the thrust direction by the dynamic pressure effect of the lubricating oil, which is generated in the thrust bearing gap, characterized in that the end surface of the hub has an oil-contact surface faced with the space filled with the lubricating oil, the oil-contact surface having a first end surface faced with the thrust bearing gap and a second end surface provided on the inner bearing side with respect to the first end surface in the axial direction.

As described above, in the present invention, of the end surface of the hub, the oil-contact surface faced with the space filled with the lubricating oil has the first end surface faced with the thrust bearing gap and the second end surface provided on the inner bearing side with respect to the first end surface in the axial direction. With this structure, the volume of the space formed between the second end surface and the surface opposed to the second end surface (end surface of the bearing sleeve, for example) in the axial direction is reduced, and hence the lubricating oil is decreased by that much. Accordingly, the thermal expansion amount of the lubricating oil can be reduced, and hence the sealing device performing a buffering function is downsized, and by extension, the bearing device is downsized.

The hub is a product formed by injection molding of a resin and having the core metal, whereby the strength of the hub can be increased when compared with the case where the hub is made only of a resin, and a material cost thereof can be decreased when compared with the case where the hub is made only of a metal. It is also possible to form the first end surface and the second end surface on the core metal. In this case, the first end surface faced with the thrust bearing gap is formed of the core metal, and hence the abrasion resistance of the first end surface is enhanced. Accordingly, at the time of low-speed rotation, such as activation and stop of the bearing device, it is possible to suppress abrasion of the first end surface, which is caused by sliding contact with the surface opposed thereto through an intermediation of the thrust bearing gap.

In the hub made of a resin, which includes the core metal, the second end surface of the core metal can be formed, for example, on the radially inner side with respect to the first end surface. In this case, when the first end surface of the core metal and the end surface on the rear side of the second end surface are formed in a flat shape free from steps, the radially inner portion of the core metal is formed to be thicker than the radially outer portion. When the core metal is fixed to the shaft member, the radially inner portion of the core metal is formed to be thick as described above, whereby the fixation strength between the core metal and the shaft member can be increased. As a result, the strength of the hub can be enhanced.

Further, in the fluid dynamic bearing device as disclosed in Patent Document 1, in which the hub having the core metal (metal portion) is used, when the metal portion is fixed along the outer peripheral surface of the shaft member, for example, through engagement involving a gap therebetween, it is difficult to enhance the fixation accuracy therebetween, which leads to a risk of deterioration in rotational accuracy of the bearing device. Further, when both the members are fixed to each other by press-fitting, there is a risk that the metal portion is deformed by press-fitting resistance. Especially, when the hub is thinned, the thickness of the metal portion is decreased in accordance therewith, and hence there is a higher risk of deformation caused by press-fitting resistance.

It is therefore an object of the present invention to provide a fluid dynamic bearing device capable of fixing the metal portion without involving deformation thereof to the shaft member with high accuracy, the metal portion being to be inserted to the hub made of a resin.

In order to achieve the above-mentioned object, the present invention provides a fluid dynamic bearing device including a shaft member, a hub protruding in a radially outward direction from the outer peripheral surface of the shaft member, and a radial bearing portion for rotatably supporting the shaft member by the dynamic pressure effect of a lubricating fluid, which is generated in the radial bearing gap faced with the outer peripheral surface of the shaft member, characterized in that the hub is a product formed by injection molding of a resin together with a metal portion as an inserted component, the metal portion being fixed to the outer peripheral surface of the shaft member in a press-fitting manner, at least one of the fixation surfaces of the metal portion and the shaft member being formed as a concave-convex surface.

As described above, in the present invention, at least one of the fixation surfaces of the metal portion and the shaft member is formed as a concave-convex surface. With this configuration, when the metal portion is press-fitted to the shaft member, the press-fitting area between the engagement surfaces can be reduced, to thereby mitigate press-fitting resistance. Accordingly, it is possible to press-fit the metal portion to the shaft member without involving deformation thereof, and hence it is possible to perform the fixation therebetween with high accuracy.

As described above, when any one of the fixation surfaces of the metal portion and the shaft member is formed as a concave-convex surface, there are formed gaps between the recessed portions of the concave-convex surface and the surface opposed thereto. Thus, there is a risk that the lubricating fluid filled inside the bearing leaks to the outside. In view of this, when the hub is formed by injection molding of a resin together with the shaft member and the metal portion fixed to the shaft member as inserted components, the resin intrudes into the gaps formed between the shaft member and the metal portion so as to fill the gaps. As a result, it is possible to prevent the lubricating oil from leaking out.

Further, when the metal portion and the shaft member are fixed to each other by welding, there is a risk that the liquated material flows into other portions, for example, onto the outer peripheral surface of the shaft member so that the bearing performance is deteriorated. In the present invention, the liquated material is captured with the gaps formed between the recessed portions of the concave-convex surface and the surface opposed thereto. As a result, it is possible to avoid the failure as described above.

The metal portion can be formed, for example, by plastic working. In this case, simultaneously with the plastic working, the concave-convex surface can be formed on the inner peripheral surface of the metal portion.

Further, in the bearing device of Patent Document 1, when a clamper for fixing a disk to the hub is screwed to the shaft member, the screw cannot be screwed thereto when the disk hub and the shaft member are rotated together with the rotation of the screw. In this context, on the upper surface of the disk hub, there is provided a hole functioning as a rotation stopper at the time of mounting the clamper (hereinafter, referred to as “rotation stopping hole”) in some cases.

The rotation stopping hole as described above can be formed, for example, simultaneously with injection molding of the disk hub. FIG. 49(a) illustrates an example of the die for molding the disk hub. The die is constituted by a movable die 121 and a fixed die 122, and a protruding portion 126 is formed as a molding portion for forming the rotation stopping hole in the movable die 121. The fixed die 122 includes a fixation hole 123 for allowing the insertion of a shaft member 127 to the axial center thereof, and a gate 124 provided near the radially outer end of the molding surface. Into a cavity 125 formed by the movable die 121 and the fixed die 122, the molten resin is injected via the gate 124. The molten resin injected from the gate 124 flows in the cavity 125 as indicated by arrows in the figure.

In this case, a molding portion 126 protrudes into the cavity 125, whereby the fluidity of the resin is deteriorated. In particular, when the core metal is inserted into the disk hub, the flow path area of the molten resin is narrowed as a result of the arrangement of the core metal in the cavity. Thus, there is a risk that the fluidity of the resin is further deteriorated, and the resin is not filled to the end portion of the cavity. For example, when the resin is not filled to the radially inner end, which is brought into contact with the shaft member 127, there is formed a gap between the radially inner end and the shaft member 127. As a result, there is a risk that the fixation strength between the shaft member 127 and the disk hub, and the oil inside the bearing leaks out through the gap.

Further, there is a risk that the molding portion 126 causes the following failure. FIG. 49(b) illustrates the flow of the molten resin on the flat surface near the protruding portion 126, the flat surface being taken perpendicularly to the axial direction. As indicated by arrows, the injected resin flows around the protruding portion 126 to the radially inner end of the cavity. In this case, when the resins bisected on the radially outer side (right side in the figure) of the protruding portion 126 meet on the radially inner side (left side in the figure) of the protruding portion 126, the weld line is formed at a meeting portion A. As a result of the formation of the weld line, there is a risk of deteriorations in strength of the disk hub and durability of the bearing device.

It is therefore an object of the present invention to enhance the dimensional accuracy, strength, and durability of the disk hub by increasing moldability of the disk hub made of a resin, which has the rotation stopping hole for mounting the clamper.

In order to achieve the above-mentioned object, the present invention provides a fluid dynamic bearing device including a shaft member, and a disk hub formed by injection molding of a resin so as to protrude in the radially outward direction with respect to the shaft member and having a disk mounting surface, the shaft member being rotatably supported by the lubricating film in the radial bearing gap faced with the outer peripheral surface of the shaft member, characterized in that the disk hub has the rotation stopping hole for mounting the clamper for fixing the disk, the rotation stopping hole being formed by removing injection gate marks of the resin molding portion.

Further, in order to achieve the above-mentioned object, the present invention provides a method of manufacturing a fluid dynamic bearing device including a shaft member, and a disk hub formed by injection molding of a resin so as to protrude in the radially outward direction with respect to the shaft member and having a disk mounting surface, the shaft member being rotatably supported by the lubricating film in the radial bearing gap faced with the outer peripheral surface of the shaft member, characterized in that the rotation stopping hole for mounting the clamper for fixing the disk is formed by removing process of injection gate marks formed in the disk hub.

As described above, in the present invention, the rotation stopping hole is formed by removing process of the injection gate marks, and hence it is unnecessary to provide a molding portion for forming the rotation stopping hole in the molding die of the disk hub. Accordingly, the fluidity of the molten resin in the cavity is secured so that the resin can be reliably filled to the end portion of the disk hub, and hence it is possible to enhance the dimensional accuracy of the disk hub. Further, the molding portion is omitted, whereby the formation of the weld line caused by the molten resin flowing around the molding portion is avoided. As a result, it is possible to enhance the strength and durability of the disk hub.

When the disk hub is a product formed by injection molding of a resin together with the core metal as an inserted component, that is, when the core metal is arranged in the cavity for molding the disk hub, it is particularly effective to secure the fluidity of the molten resin in the cavity through application of the present invention.

Further, in the manufacturing method of the present invention, the removing process of the gate marks and the formation of the rotation stopping hole can be performed within the same process. Therefore, it is possible to reduce the number of manufacturing processes of the bearing device, and to increase the production efficiency.

### Effects of the Invention

As described above, according to the present invention, in the fluid dynamic bearing device provided with the hub made of a resin, which has the core metal, the moldability thereof can be enhanced while the strength of the hub is maintained. Further, with this structure, the shear drop to the inner bearing side does not occur at the radially inner end of the hub, and it is possible to avoid deterioration in fluidity of the lubricant.

Further, as described above, in the fluid dynamic bearing device of the present invention, the end surface of the hub, which forms the thrust bearing gap, is positioned with respect to the shaft member with high accuracy in the axial direction. As a result, the bearing performance can be increased.

### BEST MODES FOR CARRYING OUT THE INVENTION

In the following, a first embodiment of the present invention is described with reference to drawings.

FIG. 1 conceptually illustrates a construction example of a spindle motor for an information apparatus incorporating a fluid dynamic bearing device 1 of the present invention. The spindle motor is used for a disk drive such as an HDD, and includes the fluid dynamic bearing device (fluid dynamic bearing device) 1 for relatively rotating and supporting a shaft member 2 in a non-contact manner, a stator coil 4 and a rotor magnet 5 opposed to each other through an intermediation of, for example, a radial gap, and a bracket 6. The stator coil 4 is mounted to an inner peripheral surface on the outer peripheral surface side of the bracket 6, and the rotor magnet 5 is fixed on the radially outer side of a hub 10 through an intermediation of a yoke 12. The fluid dynamic bearing device 1 is fixed to the inner periphery of the bracket 6. Further, one or multiple disks as information recording media (not shown) are held on the hub 10. In the spindle motor constructed as described above, when the stator coil 4 is energized, the rotor magnet 5 is rotated with an excitation force generated between the stator coil 4 and the rotor magnet 5. In accordance therewith, the hub 10 and disks held on the hub 10 are integrally rotated with the shaft member 2.

FIG. 2 illustrates the fluid dynamic bearing device 1. This fluid dynamic bearing device 1 mainly includes the shaft member 2, the hub 10 protruding in the radially outward direction of the shaft member 2, a bearing sleeve 8 having the shaft member 2 inserted along the inner periphery thereof, a housing 9 for holding the bearing sleeve 8, and a lid member 11 for closing one end of the housing 9. Note that, for the sake of convenience in description, description is made as follows on the assumption that, of the opening portions of the housing 9, which are formed at both axial ends, the side on which the housing 9 is closed with the lid member 11 is a lower side, and the side opposite to the closed side is an upper side.

In the fluid dynamic bearing device 1, radial bearing portions R1 and R2 are provided while being axially separated from each other between an outer peripheral surface 2a of the shaft member 2 and an inner peripheral surface 8a of the bearing sleeve 8. Further, a first thrust bearing portion T1 is provided between a lower end surface 8b of the bearing sleeve 8 and an upper end surface 2b1 of a flange portion 2b of the shaft member 2, and a second thrust bearing portion T2 is provided between an upper end surface 9a of the housing 9 and a lower end surface 10a1 of a disk portion 10a of the hub 10.

The bearing sleeve 8 is formed in a cylindrical shape with use of a porous body made of a sintered metal including, for example, copper as a main component. The bearing sleeve 8 is fixed to an inner peripheral surface 9c of the housing 9 by an appropriate means such as bonding (including loose bonding), press-fitting (including press-fit bonding), or adhesion (including ultrasonic adhesion).

As illustrated in FIG. 3, in the entire or a partially cylindrical region of the inner peripheral surface 8a of the bearing sleeve 8, regions where multiple dynamic pressure grooves 8a1 and 8a2 are arranged in a herringbone pattern are formed while being axially separated from each other. Further, as illustrated in FIG. 4, in the entire or a partially annular region of the lower end surface 8b of the bearing sleeve 8, a region where multiple dynamic pressure grooves 8b1 are arranged in a spiral pattern is formed.

The housing 9 is formed in a substantially cylindrical shape with use of a metal material or a resin material so as to be opened at both axial ends thereof, with the opening portion on one end side being sealed with the lid member 11. As illustrated in FIG. 5, in the entire or a partially annular region of the upper end surface 9a of the housing 9, there is formed a region where multiple dynamic pressure grooves 9a1 are arranged in a spiral pattern. Along the upper outer periphery of the housing 9, there is formed a first tapered surface 9b gradually enlarged upward. A cylindrical surface 9e is formed along the lower outer periphery of the housing 9. The cylindrical surface 9e is fixed along the inner periphery of the bracket 6 by means such as bonding, press-fitting, or adhesion. The lid member 11 for sealing the lower end side of the housing 9 is formed of a metal or a resin, and is fixed to a step portion 9d provided on the inner peripheral side of the lower end of the housing 9 by means such as bonding, press-fitting, or adhesion.

The shaft member 2 is formed of a metal, for example. At the lower end of the shaft member 2, the flange portion 2b is separately provided as a detachment stopper. The flange portion 2b is made of a metal, and fixed to the shaft member 2 by means such as screwing or bonding.

The hub 10 is constituted by a core metal 13 and a resin portion 14, and configurationally includes the disk portion 10a for covering the upper opening portion of the housing 9, a cylindrical portion 10b extending axially downward from the outer peripheral portion of the disk portion 10a, and a brim portion 10c protruding to the radially outer side from the cylindrical portion 10b. The disks (not shown) are engaged along the outer periphery of the disk portion 10a, and placed onto a disk mounting surface 10d which is formed on the upper end surface of the brim portion 10c. Then, the disks are held on the hub 10 by an appropriate means (not shown) (such as clamper). As described above, the hub 10 made of a resin includes the core metal 13, whereby the strength of the hub 10 can be increased. As a result, it is possible to prevent deformation of the hub 10 due to a clamping force at the time of disk mounting.

The core metal 13 is formed, for example, by plastic working of stainless steel (press working, for example), and configurationally includes a disk portion 13a extending in the radially outward direction from the outer peripheral surface 2a of the shaft member 2 and a cylindrical portion 13b extending axially downward from the radially outer end of the disk portion 13a. A lower end surface 13a1 of the disk portion 13a of the core metal 13 is exposed on the lower end surface 10a1 of the disk portion 10a of the hub 10, and an inner peripheral surface 13b1 and an outer peripheral surface 13b2 of the cylindrical portion 13b of the core metal 13 are respectively exposed on an inner peripheral surface 10b1 and an outer peripheral surface 10b2 of the cylindrical portion 10b of the hub 10. With this structure, the whole portion of the hub 10, which faces the space filled with the lubricant inside the bearing, is formed of the core metal 13. Accordingly, a resin material of the resin portion 14 of the hub 10 need not to have resistance to the lubricant, and hence kinds of the materials of the resin portion 14 increase. Further, the lower end portion of the radially inner end of the disk portion 10a of the hub 10 is formed of the core metal 13. Thus, there is no risk that the resin is molten in this portion, and hence failures caused by the molten resin can be prevented.

The lower end surface 10a1 of the disk portion 10a of the hub 10 is opposed to a region of the upper end surface 9a of the housing 9, where the dynamic pressure grooves are formed, through an intermediation of a thrust bearing gap. Those surfaces are brought into sliding contact with each other at the time of low-speed rotation, such as activation and stop of the bearing device, and hence is necessary to have high abrasion resistance. In this embodiment, the core metal 13 is exposed on the lower end surface 10a1 of the disk portion 10a of the hub 10, whereby higher abrasion resistance can be achieved when compared with that of a resin.

In the inner peripheral surface 10b1 of the cylindrical portion 10b of the hub 10, that is, the portion of the inner peripheral surface 13b1 of the cylindrical portion 13b of the core metal 13, which is opposed to the first tapered surface 9b provided to the outer peripheral upper end of the housing 9, there is formed a second tapered surface 10b10 having a so-called undercut shape in which the second tapered surface 10b10 is enlarged upward. A taper angle of the second tapered surface 10b10 with respect to the axial direction is set to be smaller than a taper angle of the first tapered surface 9b. With this configuration, a tapered seal space S is formed between the first tapered surface 9b and the second tapered surface 10b10, with the radial dimension thereof being gradually decreased upward. When the hub 10 (shaft member 2) is rotated, the seal space S is communicated with the radially outer side of the thrust bearing gap of the thrust bearing portion T2. In a state of being filled in the fluid dynamic bearing device 1, the lubricating oil described later is drawn to the narrower side of the seal space S by a capillary force. As a result, the oil surface thereof is constantly retained within the range of the seal space S. Further, the outer peripheral portion of the seal space S is defined by the second tapered surface 10b10, and hence the lubricating oil is pressed upward by the tapered surface 10b10 when a centrifugal force is applied to the lubricating oil in the seal space S. Therefore, the lubricating oil can be more reliably retained inside the seal space S.

To the lower outer peripheral surface 10b2 of the cylindrical portion 10b and the lower end surface of the brim portion 10c of the hub 10, the metal yoke 12 is bonded to be fixed. Generally, an adhesive force of an adhesive exerted between a metal and a resin is smaller than that exerted between metals. Accordingly, when the metal yoke 12 is bonded to be fixed not only to the brim portion 10c made of a resin but also to the lower outer peripheral surface 10b2 of the cylindrical portion 10b formed of the core metal 13 as described above, the fixation strength between the yoke 12 and the hub 10 is enhanced.

In an upper end surface 10a2 of the disk portion 10a of the hub 10, a clamping hole 10a20 is provided. When the clamper is screwed to the upper end portion of the shaft member 2 for the purpose of fixing the disks to the disk mounting surface 10d, a jig is inserted into the clamping hole 10a20, whereby the hub 10 is prevented from being rotated. As long as being provided in the upper end surface 10a2 of the disk portion 10a of the hub 10, the clamping hole 10a20 is not restricted in formation portion and number, for example, equiangularly provided at three portions. The clamping hole 10a20 is formed, for example, by machining or die molding simultaneously with injection molding of the resin portion 14.

The core metal 13 is fixed to the shaft member 2 by press-fit engaging the inner peripheral surface of the disk portion 13a and the outer peripheral surface 2a of the shaft member 2 with each other and by welding the press-fit engagement surface. The core metal 13 and the shaft member 2 thus fixed are inserted and subjected to resin injection molding, whereby the resin portion 14 of the hub 10 is formed. The resin portion 14 is molded by injection molding of a resin composite which includes the following as a base resin, for example, a crystalline resin such as liquid crystal polymer (LCP), polyphenylene sulfide (PPS), and polyether ether ketone (PEEK), or an amorphous resin such as polyphenylsulfone (PPSU), polyethersulfone (PES), and polyetherimide (PEI). Further, fiber filler such as carbon fiber or glass fiber, whisker filler such as potassium titanate, scale-like filler such as mica, carbon black, black lead, carbon nano material, or fiber or powder conductive filler such as metal powders of various types can be used while being mixed by an appropriate amount with the above-mentioned base resin in accordance with purposes.

In the following, the injection molding process of the hub 10 is described with reference to FIG. 6.

FIG. 6 illustrates a molding die of the hub 10. The die is constituted by a fixed die 21 and a movable die 22. The movable die 22 has an end surface 22a brought into contact with the lower end surface 13a1 of the disk portion 13a of the core metal 13, an axial fixation hole 23 provided at the axial center of the end surface 22a, and an annular groove 24 provided on the outer peripheral side of the end surface 22a. The shaft member 2 is inserted into the fixation hole 23, and the core metal 13 is inserted into the annular groove 24. As a result, the shaft member 2 and the core metal 13 are positioned in a cavity 25. In this state, the tapered surface (first tapered surface 10b10) provided on the inner peripheral surface 13b1 of the cylindrical portion 13b of the core metal 13 is faced with a cylindrical surface 27 provided on the movable die 22 through an intermediation of a radial gap.

In the molding surface of the movable die 22, a gate 26 is provided at the portion where the lower end surface of the brim portion 10c of the hub 10 is molded. Via the gate 26, the molten resin is injected into the cavity 25. As described above, the core metal 13 is brought into contact with the end surface 22a of the movable die 22, that is, arranged on one end side of the cavity 25. Therefore, the cavity 25 is not divided by the core metal 13, and the flow-path area of the injected molten resin can be secured.

Further, on the inner peripheral surface 10b1 of the cylindrical portion 10b of the hub 10, the first tapered surface 10b10 is formed as described above. The first tapered surface 10b10 is formed in a so-called undercut shape in which the first tapered surface 10b10 is enlarged upward. Thus, when being formed of a resin, for example, the first tapered surface 10b10 is forcibly pulled at the time of demolding after injection molding. Thus, there is a risk of damaging the first tapered surface 10b10. In the present invention, the first tapered surface 10b10 is not a molded surface, but is formed of the core metal 13 exposed from the hub 10. Thus, the die configuration of the portion opposed to this portion is used as the cylindrical surface 27. With this configuration, the first tapered surface 10b10 of the hub 10 does not interfere with the die at the time of demolding after injection molding, whereby the first tapered surface 10b10 is prevented from being damaged.

In the fluid dynamic bearing device 1, for example, a lubricating oil is filled as lubricant. Specifically, of the space formed between the shaft member 2 and the hub 10, and the bearing sleeve 8, the housing 9, and the lid member 11, the whole space on the inner bearing side with respect to the seal space S is filled with the lubricating oil. In this case, the oil surface is retained within the seal space S. Examples of the lubricating oil include ones of various types. As a lubricating oil provided to the fluid dynamic bearing device for a disk drive such as an HDD, in consideration of changes in temperature during use and transportation thereof, it is possible to suitably use an ester-based lubricating oil superior in low evaporation rate and low viscosity, for example, a lubricating oil including dioctyl sebacate (DOS) or dioctyl azelate (DOZ) as a base oil.

In the fluid dynamic bearing device 1 constructed as described above, when the shaft member 2 is rotated, radial bearing gaps are formed between the regions where the dynamic pressure grooves 8a1 and 8a2 formed in the inner peripheral surface 8a of the bearing sleeve 8 are formed and the outer peripheral surface 2a of the shaft member 2 opposed thereto. Then, in accordance with the rotation of the shaft member 2, the lubricating oil in the radial bearing gaps are pressed to the central side in the axial direction of the dynamic pressure grooves 8a1 and 8a2, and the pressure thereof is increased. As described above, owing to the dynamic pressure effect of the lubricating oil, which is generated by the dynamic pressure grooves 8a1 and 8a2, the first radial bearing portion R1 and the second radial bearing portion R2 for supporting the shaft member 2 in the radial direction in a non-contact manner are constituted, respectively.

Simultaneously, between a region where the dynamic pressure grooves 8b1 of the lower end surface 8b of the bearing sleeve 8 are formed and the upper end surface 2b1 of the flange portion 2b, and between a region where the dynamic pressure grooves 9a1 of the upper end surface 9a of the housing 9 are formed and the lower end surface 10a1 of the hub 10, the thrust bearing gaps are respectively formed. The pressure of the lubricating oil film formed in those thrust bearing gaps is increased by the dynamic pressure effect of the dynamic pressure grooves 8b1 and 9a1. As a result, the first thrust bearing portion T1 and the second thrust bearing portion T2 for supporting the shaft member 2 and the hub 10 in the thrust direction in a non-contact manner are formed, respectively.

Further, in this embodiment, an axial groove 8d1 is formed in an outer peripheral surface 8d of the bearing sleeve 8. With this configuration, the lubricating oil filled inside the bearing can be circulated, and hence it is possible to prevent generation of bubbles involved in local generation of negative pressure. Specifically, it is possible to circulate the lubricating oils filled in the gap between the lower end surface 10a1 of the disk portion 10a of the hub 10 and an upper end surface 8c of the bearing sleeve 8, the bearing gaps of the first and second radial bearing portions R1 and R2, the bearing gap of the first thrust bearing portion T1. In this embodiment, the dynamic pressure grooves 8a1 formed in the inner peripheral surface 8a of the bearing sleeve 8 are formed asymmetrically in the axial direction so as to press downward the lubricating oil in the bearing gap of the first radial bearing portion R1, whereby the lubricating oil inside the bearing is forcibly circulated (refer to FIG. 3). When the forcible circulation as described above is not particularly necessary, the dynamic pressure grooves 8a1 may be formed symmetrically in the axial direction.

The present invention is not limited to the above-mentioned embodiment. Other embodiments of the present invention are described in the following. Note that, in the following description, the parts having the same structures and functions as those in above-mentioned embodiment are denoted by the same reference symbols, and description thereof is omitted.

In the above-mentioned embodiment, while the yoke 12 separately formed is bonded to be fixed to the core metal 13, this should not be construed restrictively. For example, as illustrated in FIG. 7, the core metal 13 and the yoke 12 can be integrally formed. An integrated component of the core metal 13 and the yoke 12 can be formed by working method such as forging, press working, or machining. When the core metal 13 and the yoke 12 is integrated as described above, it is possible to reduce the numbers of components and processes, and to increase the fixation strength and the fixation accuracy between the core metal 13 and the yoke 12.

Alternatively, as illustrated in FIG. 8, the rotor magnet 5 can be directly fixed to the outer peripheral surface 13b2 of the cylindrical portion 13b of the core metal 13, which is exposed from the hub 10. In this case, the cylindrical portion 13b of the core metal 13 functions as a yoke for preventing magnetic flux leakage. With this structure, the yoke 12 in the above-mentioned embodiment can be omitted so as to achieve cost reduction. In this case, the yoke is not provided above the rotor magnet 5, and hence this structure can be applied to a fluid dynamic bearing device in which the risk of magnetic flux leakage is small.

In the above-mentioned embodiment, while the thrust bearing portions T1 and T2 are separately provided in the axial direction, this should not be construed restrictively. For example, it is possible to adopt a so-called single thrust structure in which the flange portion 2b and the first thrust bearing portion T1 are omitted so that support in the thrust direction is performed only by the second thrust bearing portion T2. In this case, in order to regulate the detachment of the shaft member 2, a detachment stopping member may be provided, for example, to at least any one of the inner peripheral surface 10b1 of the hub 10 and the outer peripheral surface of the housing 9.

Next, a second embodiment of the present invention is described with reference to FIGS. 11 to 17.

FIG. 11 conceptually illustrates a construction example of a spindle motor for an information apparatus incorporating a fluid dynamic bearing device 201 of the present invention. This spindle motor is used for a disk drive such as an HDD, and includes the fluid dynamic bearing device 201 for relatively rotating and supporting a shaft member 202 in a non-contact manner, a stator coil 204 and a rotor magnet 205 opposed to each other through an intermediation of, for example, a radial gap, and a bracket 206. The stator coil 204 is mounted to an inner peripheral surface 206a on the outer peripheral surface side of the bracket 206, and the rotor magnet 205 is fixed to the outer periphery of the hub 203. The fluid dynamic bearing device 201 is fixed to the inner periphery of the bracket 206. Further, one or multiple disks as information recording media (not shown) are held on the hub 203. In the spindle motor constructed as described above, when the stator coil 204 is energized, the rotor magnet 205 is rotated with an excitation force generated between the stator coil 204 and the rotor magnet 205. In accordance therewith, the hub 203 and disks held on the hub 203 are integrally rotated with the shaft member 202.

FIG. 12 illustrates the fluid dynamic bearing device 201. The fluid dynamic bearing device 201 mainly includes the shaft member 202, a flange member 209 provided at one end of the shaft member 202, the flange-like hub 203 provided at the other end of the shaft member 202, a bearing sleeve 208 having the shaft member 202 inserted along the inner periphery thereof, a housing 207 opened on both the axial sides thereof for holding the bearing sleeve 208, and a lid member 270 for closing the opening portion of the one end of the housing 207. Note that, for the sake of convenience in description, description is made as follows on the assumption that, of the opening portions formed on both the axial end sides of the housing 207, the side on which the housing 207 is closed with the lid member 270 is a lower side, and the open side is an upper side.

In the fluid dynamic bearing device 201, while being described later in detail, the radial bearing portions R1 and R2 are provided while being axially separated from each other between a larger diameter outer peripheral surface 202a of the shaft member 202 and an inner peripheral surface 208a of the bearing sleeve 208. Further, the first thrust bearing portion T1 is provided between an upper end surface 207a of the housing 207 and a lower end surface 203a1 of a disk portion 203a of the hub 203, and the second thrust bearing portion T2 is provided between an upper end surface 209a of the flange member 209 and a lower end surface 208b of the bearing sleeve 208.

The bearing sleeve 208 is formed in a cylindrical shape with use of a porous body made of a sintered metal including, for example, copper as a main component. The bearing sleeve 208 is fixed to an inner peripheral surface 207c of the housing 207 by an appropriate means such as bonding, press-fitting (including press-fit bonding), adhesion (including ultrasonic adhesion), or welding (including laser welding).

As illustrated in FIG. 13, in the entire or a partially cylindrical region of the inner peripheral surface 208a of the bearing sleeve 208, regions where multiple dynamic pressure grooves 208a1 and 208a2 are arranged in a herringbone pattern are formed while being axially separated from each other. The dynamic pressure grooves 208a1 on the upper side are formed asymmetrically in the axial direction. Specifically, an axial dimension X of the grooves on the upper side with respect to an annular smooth portion provided at the axial intermediate portion is larger than an axial dimension Y of the grooves on the lower side. Meanwhile, the dynamic pressure grooves 208a2 is formed symmetrically in the axial direction.

In the entire or a partially annular region of the lower end surface 208b of the bearing sleeve 208, there are formed dynamic pressure grooves (not shown) arrange in a spiral pattern. Further, in an outer peripheral surface 208d of the bearing sleeve 208, one or multiple axial grooves 208d1 are equiangularly formed.

The housing 207 is formed in a substantially cylindrical shape with use of a metal material or a resin material so as to be opened at both axial ends thereof, with the opening portion on the lower side being sealed with the lid member 270. The lid member 270 is held in contact with a step portion 207f formed along the lower inner periphery of the housing 207 and is fixed thereto by means such as bonding, press-fitting, adhesion, or welding. As illustrated in FIG. 14, in the entire or a partially annular region of the upper end surface 207a of the housing 207, there is formed a region where multiple dynamic pressure grooves 207a1 are arranged in a spiral pattern. Along the upper outer periphery of the housing 207, there is formed a first tapered surface 207b gradually enlarged upward. A seal space S is formed between the first tapered surface 207b and a second tapered surface 203b1 formed on the hub 203 described later. Along the lower outer periphery of the housing 207, there is formed a cylindrical surface 207e. The cylindrical surface 207e is fixed along the inner periphery of the bracket 206 by means such as bonding, press-fitting, adhesion, or welding.

The shaft member 202 is formed in a shape of stepped shaft with use of a metal material such as stainless steel. Specifically, the shaft member 202 includes the larger diameter outer peripheral surface 202a, a smaller diameter outer peripheral surface 202b provided on the upper side of the larger diameter outer peripheral surface 202a, and a radial shoulder surface 202c formed therebetween. The hub 203 is formed along the smaller diameter outer peripheral surface 202b of the shaft member 202 in a flange-like configuration, and a radial bearing gap is formed between the larger diameter outer peripheral surface 202a and the inner peripheral surface 208a of the bearing sleeve 208.

The flange member 209 is provided at the lower end portion of the shaft member 202. The flange member 209 is screwed to the shaft member 202 through an intermediation of a screw hole provided at the lower end portion thereof, and is brought into contact with a lower end surface 202d of the shaft member 202, thereby positioned with respect to the shaft member 202. A thrust bearing gap is formed between the upper end surface 209a of the flange member 209 and the lower end surface 208b of the bearing sleeve 208. Note that, the fixation method between the flange member 209 and the shaft member 202 is not limited to the above-mentioned one. For example, both the members may be fixed by bonding.

The hub 203 is provided along the smaller diameter outer peripheral surface 202b of the shaft member 202 in a flange-like configuration, and is formed by injection molding while being inserted with a core metal 231. The hub 203 includes the disk portion 203a for covering the upper opening portion of the housing 207, a cylindrical portion 203b extending axially downward from the outer peripheral portion of the disk portion 203a, and a brim portion 203c protruding to the radially outer side from the cylindrical portion 203b. The disks (not shown) are engaged along the outer periphery of the disk portion 203a, and placed onto a disk mounting surface 203d which is formed on the upper end surface of the brim portion 203c. Then, the disks are held on the hub 203 by an appropriate means (not shown) (such as clamper). As described above, the hub 203 made of a resin includes the core metal 231, whereby the strength of the hub 203 can be increased. As a result, it is possible to prevent deformation of the hub 203 due to a clamping force at the time of disk mounting.

The core metal 231 is formed in a substantially disk-like shape, for example, by plastic working of stainless steel (press working, for example). The core metal 231 is positioned in the axial direction while an inner peripheral surface 231b thereof is engaged with the smaller diameter outer peripheral surface 202b of the shaft member 202 in a press-fitting manner (including light press-fitting manner) and a lower end surface 231a thereof is brought into contact with the shoulder surface 202c of the shaft member 202. In this case, an escape portion 202e (refer to FIG. 15) is formed in a boundary portion between the smaller diameter outer peripheral surface 202b of the shaft member 202 and the shoulder surface 202c, and hence the core metal 231 can be reliably held in close contact with the shoulder surface 202c of the shaft member 202. In this state, the core metal 231 and the shaft member 202 is welded through an intermediation of the engagement surface therebetween, thereby being fixed to each other.

The core metal 231 and the shaft member 202 fixed as described above are inserted and subjected to resin injection molding, whereby the resin molded portion 232 of the hub 203 is formed. The resin molded portion 232 is molded by injection molding of a resin composite which includes the following as a base resin, for example, a crystalline resin such as liquid crystal polymer (LCP), polyphenylene sulfide (PPS), and polyether ether ketone (PEEK), or an amorphous resin such as polyphenylsulfone (PPSU), polyethersulfone (PES), and polyetherimide (PEI). Further, fiber filler such as carbon fiber or glass fiber, whisker filler such as potassium titanate, scale-like filler such as mica, carbon black, black lead, carbon nano material, or fiber or powder conductive filler such as metal powders of various types can be used while being mixed by an appropriate amount with the above-mentioned base resin in accordance with purposes.

Further, the material for injection molding of the hub 203 is not limited to a resin, and a molten metal can be used therefor. Examples of the applicable metal materials include a low melting metal material such as a magnesium alloy or an aluminum alloy. In this case, higher strength and conductivity can be achieved when compared with the case of using a resin material. In addition, there can be adopted so-called MIM molding in which a composite of a metal powder and a binder is injection-molded before being degreased and sintered, or injection molding with use of ceramic (so-called CIM molding).

A resin molded portion 232 of the hub 203 is brought into contact with the smaller diameter outer peripheral surface 202b of the shaft member 202. The smaller diameter outer peripheral surface 202b is provided with concaves and convexes, and a molted resin as an injection material is caused to intrude into the concave-convex portion. As a result, an anchoring effect is exerted so that the fixation force between the resin molded portion 232 and the shaft member 202 is increased. The concave-convex portion is formed, for example, by leaving lathe-turning marks as a result of lathe-turning the shaft member 202 as described later in the smaller diameter outer peripheral surface 202b. In addition, as illustrated in FIG. 16, for example, the concave-convex portion can be formed with use of a spline groove 202b1 formed in the smaller diameter outer peripheral surface 202b.

Along the upper portion of the inner peripheral surface of the cylindrical portion 203b of the hub 203, the second tapered surface 203b1 gradually enlarged upward is formed. A taper angle of the second tapered surface 203b1 with respect to the axial direction is set to be smaller than a taper angle of the first tapered surface 207b. Accordingly, the seal space S formed therebetween is formed in a tapered shape in which the radial dimension thereof is gradually decreased upward. As described above, with the structure in which the outer peripheral portion of the seal space S is the second tapered surface 203b1 gradually enlarged upward, when the hub 203 is rotated, in addition to the drawing effect by a capillary force of the tapered seal space S, the lubricating oil in the seal space S drawn upward, that is, to the inside of the bearing by a centrifugal force. As a result, the leakage of the lubricating oil to the outside can be more reliably prevented.

In the fluid dynamic bearing device 201, for example, a lubricating oil is filled as lubricant, and the oil surface is constantly retained within the seal space S. Examples of the lubricating oil include ones of various types. As a lubricating oil provided to the fluid dynamic bearing device for a disk drive such as an HDD, in consideration of changes in temperature during use and transportation thereof, it is possible to suitably use an ester-based lubricating oil superior in low evaporation rate and low viscosity, for example, a lubricating oil including dioctyl sebacate (DOS) or dioctyl azelate (DOZ) as a base oil.

In the fluid dynamic bearing device 201 constructed as described above, when the shaft member 202 is rotated, the radial bearing gaps are formed between the regions where the dynamic pressure grooves 208a1 and 208a2 formed in the inner peripheral surface 208a of the bearing sleeve 208 are formed and the larger diameter outer peripheral surface 202a of the shaft member 202 opposed thereto. Then, in accordance with the rotation of the shaft member 202, the lubricating oil in the radial bearing gaps are pressed to the central side in the axial direction of the dynamic pressure grooves 208a1 and 208a2, and the pressure thereof is increased. Owing to the dynamic pressure effect of the lubricating oil, which is generated by the dynamic pressure grooves 208a1 and 208a2, the first radial bearing portion R1 and the second radial bearing portion R2 for supporting the shaft member 202 in the radial direction in a non-contact manner are constituted, respectively.

Simultaneously, the thrust bearing gap is formed between a region where the dynamic pressure grooves 207a1 of the upper end surface 207a of the housing 207 are formed and the lower end surface 203a1 of the hub 203, and the thrust bearing gap is formed between a region where the dynamic pressure grooves of the lower end surface 208b of the bearing sleeve 208 are formed and the upper end surface 209a of the flange member 209. The pressure of the lubricating oil film formed in those thrust bearing gaps is increased by the dynamic pressure effect of the dynamic pressure grooves. As a result, the first thrust bearing portion T1 and the second thrust bearing portion T2 for supporting the shaft member 202 and the hub 203 in both the thrust directions in a non-contact manner are formed.

Further, an axial groove 208d1 is formed in an outer peripheral surface 208d of the bearing sleeve 208. The space on the radially outer side of the second thrust bearing portion T2 and the space on the radially inner side of the first thrust bearing portion T1 can be communicated with each other. With this structure, it is possible to prevent generation of bubbles caused by local generation of negative pressure in the inner space of the bearing. Further, in this embodiment, as illustrated in FIG. 3, the dynamic pressure grooves 208a1 of the first radial bearing portion R1 are formed asymmetrically in the axial direction, and hence the lubricating oil is pressed downward into the bearing gap. As a result, the lubricating oil circulates through the path constituted by the radial bearing gap, the thrust bearing gap of the second thrust bearing portion T2, the axial groove 208d1, the space between an upper end surface 208c of the bearing sleeve 208 and the hub 203 in the stated order so as to be drawn into the radial bearing gap again. With the forcible circulation of the lubricating oil inside the bearing as described above, local generation of the negative pressure is more reliably prevented. Note that, when the forcible circulation as described above is not particularly necessary, the dynamic pressure grooves 208a1 may be formed symmetrically in the axial direction.

As described above, in the present invention, the thrust bearing gap of the first thrust bearing portion T1 is formed of the core metal 231. Thus, unlike the conventional products in which the core metal is covered with a resin, the accuracy of end surface is not deteriorated owing to mold shrinkage. Accordingly, the end surface 231a of the core metal 231 is brought into contact with the shoulder surface 202c of the shaft member 202, whereby the end surface 231a of the core metal 231 can be positioned with respect to the shaft member 202 in the axial direction with high accuracy. Specifically, the core metal 231 is positioned with respect to the lower end surface 202d of the shaft member 202 with high accuracy, whereby an axial distance L (refer to FIG. 2) with respect to the flange member 209 positioned by being brought into contact with the lower end surface 202d can be set with high accuracy. With this configuration, the total amount of the gap widths of both the thrust bearing portions T1 and T2 can be set with high accuracy, thereby increasing the supporting force in the thrust direction.

Further, at the time of low-speed rotation, such as activation and stop of the bearing device, the dynamic pressure effect of the dynamic pressure grooves is not sufficiently exerted. Thus, the lower end surface 203a1 of the disk portion 203a of the hub 203 is held in slide contact with the upper end surface 207a of the housing 207, which is opposed thereto through an intermediation of the thrust bearing gap. For this reason, the lower end surface 203a1 of the disk portion 203a of the hub 203, which forms the thrust bearing gap, is necessary to have high abrasion resistance. As described above, the lower end surface 203a1 of the disk portion 203a of the hub 203 is formed by the lower end surface 231a of the core metal 231, thereby increasing abrasion resistance of the portion subjected to sliding contact at the time of low-speed rotation.

In the following, a working method of the shaft member 202 is described with reference to FIG. 5.

First, a cylindrical shaft material made of stainless steel is cut at a predetermined length, and the outer peripheral surface of the shaft material is lathe-turned. In this manner, the larger diameter outer peripheral surface 202a, the smaller diameter outer peripheral surface 202b, and the shoulder surface 202c are formed on the shaft member 202. Those surfaces are coarse surfaces having lathe-turning marks formed therein. Simultaneously with the lathe turning the escape portion 202e is formed in the boundary portion between the smaller diameter outer peripheral surface 202b and the shoulder surface 202c.

After that, the larger diameter outer peripheral surface 202a and the shoulder surface 202c of the shaft member 202 are grinded, thereby increasing the surface accuracy of those surfaces. In the grinding, there are used an angular grindstone 240 rotated about the axis inclined with respect to the central axis of the shaft member 202, and a positioning jig 250 held in contact with the lower end surface 202d of the shaft member 202 (refer to FIG. 15). The grindstone 240 has a first grinding surface 241 for grinding the larger diameter outer peripheral surface 202a of the shaft member 202, a second grinding surface 242 for grinding the shoulder surface 202c of the shaft member 202, and a third grinding surface 243 opposite to the smaller diameter outer peripheral surface 202b of the shaft member 202. A radial dimension L1 (dimension in the radial direction of the shaft member 202) of the second grinding surface 242 is set to be smaller than a radial dimension L2 of the shoulder surface 202c of the shaft member 202 (L1<L2). When the grindstone 240 as described above is rotated to grind the shaft member 202, while the larger diameter outer peripheral surface 202a and the shoulder surface 202c of the shaft member 202 are respectively grinded with the first grinding surface 241 and the second grinding surface 242, the smaller diameter outer peripheral surface 202b and the third grinding surface 243 can be made non-contact with each other. With this configuration, it is possible to form the larger diameter outer peripheral surface 202a and the shoulder surface 202c as grinded surfaces worked with high accuracy, and to form the smaller diameter outer peripheral surface 202b as a coarse surface in which lathe-turning marks as a result of lathe turning are left.

Further, as illustrated in FIG. 15, in a state in which the positioning jig 250 is held in contact with the lower end surface 202d of the shaft member 202, that is, with reference to the lower end surface 202d of the shaft member 202, the shoulder surface 202c is grinded with the second grinding surface 242, thereby setting an axial distance L3 between the shoulder surface 202c and the lower end surface 202d of the shaft member 202 with high accuracy. Note that, when the lower end surface 202d of the shaft member 202 is grinded in advance so as to increase the surface accuracy of this surface, the axial positioning thereof can be performed more accurately through contact with respect to the positioning jig 250. As a result, the axial distance between the shoulder surface 202c and the lower end surface 202d of the shaft member 202 is set more accurately.

As described above, as a result of grinding the shoulder surface 202c of the shaft member 202 so as to increase the surface accuracy of this surface, the positioning accuracy of the core metal 231 with respect to the shaft member 202 is increased. Further, as a result of grinding the 202c of the shaft member 202 with reference to the lower end surface 202d, the axial distance L3 between the shoulder surface 202c and the lower end surface 202d is set with high accuracy. With this configuration, the accuracy in setting an axial distance L between the core metal 231 and the flange member 209 is further increased, and the width accuracy of the thrust bearing gap is enhanced, with the result that the supporting force in the thrust direction is further increased.

Further, as described above, the larger diameter outer peripheral surface 202a and the shoulder surface 202c of the shaft member 202 are simultaneously grinded with the grindstone 240, whereby the number of processes is reduced, and perpendicularity and fluctuation accuracy between those surfaces can be set with high accuracy. With this configuration, perpendicularity and fluctuation accuracy between the radial bearing gap defined by the larger diameter outer peripheral surface 202a and the thrust bearing gap defined by the core metal 231 which is positioned with the shoulder surface 202c can be set with high accuracy. Accordingly, as a result of enhancement in width accuracy of the bearing gap, the supporting force can be increased and the rotational accuracy of the shaft member 202 can be enhanced.

The present invention is not limited to the above-mentioned embodiment. Other embodiments of the present invention are described in the following. Note that, in the following description, the parts having the same structures and functions as those in above-mentioned embodiment are denoted by the same reference symbols, and description thereof is omitted.

FIG. 17 illustrates the fluid dynamic bearing device 201 according to another embodiment of the present invention. In the fluid dynamic bearing device 201, the flange member provided at the lower end of the shaft member 202 in the above-mentioned embodiment, and the second thrust bearing portion which is formed of the flange member are omitted. To a step portion 203e provided in the upper portion of the inner periphery of the cylindrical portion 203b of the hub 203, a detachment stopping member 210 is fixed by means such as bonding or welding. The detachment stopping member 210 is formed, for example, in a substantially L-shaped cross-section by press working of a metal material. An upper end surface 210a and the radial shoulder surface provided along the outer periphery of the housing 207 are engaged with each other in the axial direction, whereby the detachment of the hub 203 and the shaft member 202 is regulated. An inner peripheral surface 210b of the detachment stopping member 210 is formed in a tapered shape gradually enlarged upward, and forms the seal space S together with the first tapered surface 207b of the housing 207 therebetween. That is, the inner peripheral surface 210b of the detachment stopping member 210 plays the same role as that of the second tapered surface 203b1 provided to the hub 203 in the above-mentioned embodiment. The housing 207 is formed in a bottomed cup shape, with the lower end surface 208b of the bearing sleeve 208 being held in contact with the inner bottom surface 207d thereof. In addition, the lower end surface 202d of the shaft member 202 is opposed to the inner bottom surface 207d of the housing 207 in the axial direction through an intermediation of a predetermined gap.

In the fluid dynamic bearing device 201, as in the above-mentioned embodiment, the shoulder surface 202c of the shaft member 202 is grinded with reference to the lower end surface 202d thereof, whereby the axial distance between the shoulder surface 202c and the lower end surface 202d is set with high accuracy. With this configuration, in a state in which the hub 203 and the shaft member 202 is supported by the thrust bearing portion T1 in the thrust direction in a non-contact manner, the axial distance between the lower end surface 202d of the shaft member 202 and an inner bottom surface 207d of the housing 207 can be set with high accuracy. Accordingly, it is possible to prevent an increase in torque caused by an excessive approximation between the lower end surface 202d of the shaft member 202 and the inner bottom surface 207d of the housing 207, an increase in capacity of the seal space S, which is caused by the space inside the bearing enlarged as a result of an excessive separation of those surfaces, and by extension, to prevent an increase in size of the bearing device.

In the above-mentioned embodiment, while the hub is formed by injection molding of the integrated component of the core metal 213 and the shaft member 202, this should not be construed restrictively. For example, the hub may be injection-molded together with the core metal as an inserted component, and then the hub may be fixed to the shaft member.

Next, a third embodiment of the present invention is described with reference to FIGS. 18 to 27.

FIG. 18 conceptually illustrates a construction example of a spindle motor for an information apparatus incorporating a fluid dynamic bearing device (fluid dynamic bearing device) 301 of the present invention. The spindle motor is used for a disk drive such as an HDD, and includes the fluid dynamic bearing device 301 for relatively rotating and supporting a shaft member 302 and a hub 310 in a non-contact manner, a stator coil 304 and a rotor magnet 305 opposed to each other through an intermediation of, for example, a radial gap, and a bracket 306. The stator coil 304 is mounted to an inner peripheral surface on the outer peripheral surface side of the bracket 306, and the rotor magnet 305 is fixed to a yoke 312 provided on the radially outer side of a hub 310. The fluid dynamic bearing device 301 is fixed to the inner periphery of the bracket 306. Further, one or multiple disks as information recording media (not shown) are held on the hub 310. In the spindle motor constructed as described above, when the stator coil 304 is energized, the rotor magnet 305 is rotated with an excitation force generated between the stator coil 304 and the rotor magnet 305. In accordance therewith, the hub 310 and disks held on the hub 310 are integrally rotated with the shaft member 302.

FIG. 19 illustrate the fluid dynamic bearing device 301. The fluid dynamic bearing device 301 is constituted by a rotary-side member 303 and a fixed-side member 307. The rotary-side member 303 includes the shaft member 302 and the hub 310 protruding provided radially outward with respect to the shaft member 302. The fixed-side member 307 includes a bearing sleeve 308, a housing 309, a lid member 311 for closing one end of the housing 309. Note that, for the sake of convenience in description, description is made as follows on the assumption that, of the opening portions of the housing 309, which are formed at both axial ends, the side on which the housing 309 is closed with the lid member 311 is a lower side, and the side opposite to the closed side is an upper side.

The radial bearing portions R1 and R2 are provided while being axially separated from each other between an outer peripheral surface 302a of the shaft member 302 and an inner peripheral surface 308a of the bearing sleeve 308. Further, the first thrust bearing portion T1 is provided between a lower end surface 308b of the bearing sleeve 308 and an upper end surface 302b1 of a flange portion 302b of the shaft member 302, and the second thrust bearing portion T2 is provided between an upper end surface 309a of the housing 309 and a lower end surface 310a1 of a disk portion 310a of the hub 310.

The bearing sleeve 308 is formed in a cylindrical shape with use of a porous body made of a sintered metal including, for example, copper as a main component. The bearing sleeve 308 is fixed to an inner peripheral surface 309c of the housing 309 by an appropriate means such as bonding (including loose bonding), press-fitting (including press-fit bonding), or adhesion (including ultrasonic adhesion).

For example, as illustrated in FIG. 20, in the entire or a partially cylindrical region of the inner peripheral surface 308a of the bearing sleeve 308, regions where multiple dynamic pressure grooves 308a1 and 308a2 are arranged in a herringbone pattern are formed as a radial dynamic pressure generating portion while being axially separated from each other. Further, for example, as illustrated in FIG. 21, in the entire or a partially annular region of the lower end surface 308b of the bearing sleeve 308, a region where multiple dynamic pressure grooves 308b1 are arranged in a spiral pattern is formed as a thrust dynamic pressure generating portion. Further, in the outer peripheral surface 308d of the bearing sleeve 308, there is formed an axial groove 308d1.

The housing 309 is formed in a substantially cylindrical shape with use of a metal material or a resin material. In this embodiment, the housing 309 has a shape of being opened at both axial ends thereof, with one end side being sealed with the lid member 311. For example, as illustrated in FIG. 22, in the entire or a partially annular region of the upper end surface 309a on the other end side, there is formed as the thrust dynamic pressure generating portion a region where multiple dynamic pressure grooves 309a1 are arranged in a spiral pattern, and in the region between the dynamic pressure grooves 309a1, there is formed a back portion 309a10. Along the upper outer periphery of the housing 309, there is formed a first tapered surface 309b gradually enlarged upward (oppositely to the sealed side). A cylindrical surface 309e is formed along the lower outer periphery of the housing 309. The cylindrical surface 309e is fixed along the inner periphery of the bracket 306 by means such as bonding, press-fitting, or adhesion.

The lid member 311 for sealing the lower end side of the housing 309 is formed of a metal or a resin, and is fixed to a step portion 309d provided on the inner peripheral side of the lower end of the housing 309 by means such as bonding, press-fitting, or adhesion.

The shaft member 302 is formed of a metal in this embodiment, and at the lower end thereof, the flange portion 302b is separately provided as a detachment stopper. The flange portion 302b is made of a metal, and fixed to the shaft member 302 by means such as screwing. At the upper end of the shaft member 302, there is formed a recessed portion (annular groove in this embodiment) 302c. When the hub 310 is formed by injection molding of a resin together with the shaft member 302 as an inserted component, the recessed portion 302c serves as a detachment stopper of the shaft member 302 with respect to the hub 310.

The hub 310 includes the disk portion 310a for covering the opening side (upper side) of the housing 309, a cylindrical portion 310b extending axially downward from the outer peripheral portion of the disk portion 310a, a brim portion 310c protruding to the radially outer side from the cylindrical portion 310b, and a disk mounting surface 310d formed at the upper end of the brim portion 310c. The disks (not shown) are engaged along the outer periphery of the disk portion 310a, and placed onto the disk mounting surface 310d. Then, the disks are held on the hub 310 by an appropriate means (not shown) (such as clamper).

The hub 310 constructed as described above is molded by injection molding of a resin composite which includes the following as a base resin, for example, a crystalline resin such as liquid crystal polymer (LCP), polyphenylene sulfide (PPS), and polyether ether ketone (PEEK), or an amorphous resin such as polyphenylsulfone (PPSU), polyethersulfone (PES), and polyetherimide (PEI). In this embodiment, the hub 310 is injection-molded together with the shaft member 302 as an inserted component. Further, fiber filler such as carbon fiber or glass fiber, whisker filler such as potassium titanate, scale-like filler such as mica, carbon black, black lead, carbon nano material, or fiber or powder conductive filler such as metal powders of various types can be used while being mixed by an appropriate amount with the above-mentioned base resin in accordance with purposes.

The lower end surface 310a1 of the disk portion 310a includes a first end surface 310a11 opposed to a region where the dynamic pressure grooves 309a1 of the upper end surface 309a of the housing 309 are formed in the thrust direction, and a second end surface 310a12 which is formed on the radially inner side of the first end surface 310a11 through an intermediation of a step in the axial direction and is provided axially below with respect to the first end surface 310a11. With this structure, the inner diameter portion of the disk portion 310a of the hub 310 is formed to be thicker than the outer diameter portion thereof. With the inner diameter portion formed to be thick, the fixation strength with respect to the shaft member 302 is increased, whereby unmating force of the hub 310 can be enhanced.

When the rotary-side member 303 is rotated, a thrust bearing gap T_{S} of the second thrust bearing portion T2 is formed between the first end surface 310a11 of the disk portion 310a of the hub 310 and the upper end surface 309a of the housing 309, and a minute gap C is formed between the second end surface 310a12 of the disk portion 310a of the hub 310 and the upper end surface 308c of the bearing sleeve 308. In this case, as illustrated in FIG. 19(b), the step (axial distance) between the first end surface 310a12 of and the second end surface 310a12 are set such that a gap width N of the minute gap C is smaller than a gap width M of the thrust bearing gap Tₛ of the second thrust bearing portion T2 (M>N).

In a portion of the inner peripheral surface of the cylindrical portion 310b, which is opposed to the first tapered surface 309b provided to the outer peripheral upper end of the housing 309, there is formed a second tapered surface 310b1 which is enlarged upward. A taper angle of the second tapered surface 310b1 with respect to the axial direction is set to be smaller than a taper angle of the first tapered surface 309b. With this configuration, a tapered seal space S is formed between the first tapered surface 309b and the second tapered surface 310b1 with the radial dimension thereof being gradually decreased upward. When the rotary-side member 303 is rotated, the seal space S is communicated with the radially outer side of the thrust bearing gap of the thrust bearing portion T2. In a state of being filled in the fluid dynamic bearing device 301, the lubricating oil described later is drawn to the narrower side of the seal space S by a capillary force. As a result, the oil surface thereof is constantly retained within the range of the seal space S. Further, the outer peripheral portion of the seal space S is defined by the second tapered surface 310b1, and hence the lubricating oil is pressed upward by the tapered surface 310b1 when a radial centrifugal force is applied to the lubricating oil in the seal space S. Therefore, the lubricating oil can be more reliably retained inside the seal space S.

The inner space of the fluid dynamic bearing device 301 constructed as described above is filled with the lubricating oil, and the oil surface thereof is retained within the seal space S. Examples of the lubricating oil filled therein include ones of various types. As a lubricating oil provided to the fluid dynamic bearing device for a disk drive such as an HDD, in consideration of changes in temperature during use and transportation thereof, it is possible to suitably use an ester-based lubricating oil superior in low evaporation rate and low viscosity, for example, a lubricating oil including dioctyl sebacate (DOS) or dioctyl azelate (DOZ) as a base oil.

In the fluid dynamic bearing device 301 constructed as described above, when the shaft member 302 is rotated, the radial bearing gaps are formed between the regions where the dynamic pressure grooves 308a1 and 308a2 formed in the inner peripheral surface 308a of the bearing sleeve 308 are formed and the outer peripheral surface 302a of the shaft member 302 opposed thereto. Then, in accordance with the rotation of the shaft member 302, the lubricating oil in the radial bearing gaps is pressed to the central side in the axial direction of the dynamic pressure grooves 308a1 and 308a2, and the pressure thereof is increased. As described above, owing to the dynamic pressure effect of the lubricating oil, which is generated by the dynamic pressure grooves 308a1 and 308a2 respectively formed in the radial bearing portion R1 and the radial bearing portion R2, the rotary-side member 303 is supported in the radial direction in a non-contact manner.

Simultaneously, a thrust bearing gap is formed between a region where the dynamic pressure grooves 308b1 in the lower end surface 308b of the bearing sleeve 308 are formed and the upper end surface 302b1 of the flange portion 302b opposed thereto, and the thrust bearing gap T-ₛ is formed between a region where the dynamic pressure grooves 309a1 in the upper end surface 309a of the housing 309 are formed and the first end surface 310a11 of the lower end surface 310a1 of the hub 310 opposed thereto. The pressure of the lubricating oil film formed in those thrust bearing gaps is increased by the dynamic pressure effect of the dynamic pressure grooves 308b1 and 309a1 respectively provided in the first thrust bearing portion T1 and the second thrust bearing portion T2. As a result, the rotary-side member 303 is supported in the thrust direction in a non-contact manner.

At the time of low-speed rotation, such as activation and stop of the bearing device, the dynamic pressure effect of the dynamic pressure grooves is not sufficiently exerted. Thus, for example, when the fluid dynamic bearing device 301 is used in the upper and lower directions as illustrated in FIG. 19, at the time of low-speed rotation, the first end surface 310a11 of the disk portion 310a of the hub 310 and the upper end surface 309a of the housing 309 come close to each other owing to the gravity. As a result, the gap width of the thrust bearing gap Tₛ approximates to zero. In the present invention, as described above, the gap width N of the minute gap C between the second end surface 310a12 formed in the lower end surface 310a1 of the disk portion 310a of the hub 310 and the upper end surface 308c of the bearing sleeve 308 is set to be smaller than the gap width M of the thrust bearing gap Tₛ of the second thrust bearing portion T2. With this configuration, at the time of low-speed rotation in which the dynamic pressure effect is not sufficiently exerted, the second end surface 310a12 of the hub 310 and the upper end surface 308c of the bearing sleeve 308, which are opposed to each other through an intermediation of the minute gap C, are brought into contact with each other. As a result, it is possible to prevent the contact between the first end surface 310a11 of the hub 310 and the upper end surface 309a of the housing 309 opposed to each other through an intermediation of the thrust bearing gap Tₛ. Accordingly, it is possible to prevent abrasion of the upper end surface 309a of the housing 309, especially, the back portion 309a10 between the dynamic pressure grooves 309a1, and hence the supporting force in the thrust direction can be maintained.

Further, the minute gap C is positioned on the radially inner side with respect to the thrust bearing gap Tₛ, and hence the circumferential velocity in the sliding contact between the surfaces opposed to each other through an intermediation of a minute gap C is lower than that in the sliding contact between the surfaces opposed to each other through an intermediation of the thrust bearing gap Tₛ. With this configuration, it is possible to suppress the abrasion of the end surface 310a1 of the hub 310 and the upper end surface 308c of the bearing sleeve 308 opposed to each other through an intermediation of the minute gap C. Further, the bearing sleeve 308 is formed of a sintered oil-impregnated metal which is an oil-impregnated material. Thus, the lubricating oil impregnated to the bearing sleeve 308 is constantly supplied to the sliding portion, whereby the lubricating property of the sliding surfaces is increased. As a result, the abrasion on those surfaces can be suppressed more effectively.

Incidentally, as described above, it is necessary to set, within the range in which the dynamic pressure effect in the thrust bearing gap Tₛ is sufficiently exerted, the step (axial distance) between the first end surface 310a11 and the second end surface 310a12 such that the gap width M of the thrust bearing gap Tₛ is larger than the gap width N of the minute gap C. It is preferable to set the step to be slightly smaller than, for example, the axial distance between the upper end surface 309a (specifically, back portion 309a10 of dynamic pressure grooves 309a1) of the housing 309 and the upper end surface 308c of the bearing sleeve 308. With this configuration, it is possible to sufficiently obtain the supporting force of the second thrust bearing portion in the thrust direction (floating force of hub 310), and hence to prevent sliding contact between the surfaces opposed to each other through an intermediation of the minute gap C during high-speed rotation.

Note that, in this embodiment, the axial groove 308d1 is formed in an outer peripheral surface 308d of the bearing sleeve 308. With this configuration, the lubricating oil filled inside the bearing can be circulated, and hence it is possible to prevent generation of bubbles involved in local generation of negative pressure. Specifically, it is possible to circulate the lubricating oils filled in the gap between the second end surface 310a12 of the disk portion 310a of the hub 310 and an upper end surface 308c of the bearing sleeve 308, the bearing gaps of the first and second radial bearing portions R1 and R2, the thrust bearing gap of the second thrust bearing portion T2. In this embodiment, the dynamic pressure grooves 308a1 formed in the inner peripheral surface 308a of the bearing sleeve 308 are formed asymmetrically in the axial direction so as to press downward the lubricating oil in the radial bearing gap of the first radial bearing portion R1, whereby the lubricating oil inside the bearing is forcibly circulated (refer to FIG. 20). When the forcible circulation as described above is not particularly necessary, the dynamic pressure grooves in the radial bearing surface may be formed symmetrically in the axial direction.

The present invention is not limited to the above-mentioned embodiment. Other embodiments of the present invention are described in the following. Note that, in the following description, the parts having the same structures and functions as those in the above-mentioned embodiment are denoted by the same reference symbols, and description thereof is omitted.

In the above-mentioned embodiment, the first end surface 310a11 and the second end surface 310a12 are formed on the lower end surface 310a1 of the disk portion 310a of the hub 310 through an intermediation of the step, and the minute gap C is formed between the second end surface 310a12 and the upper end surface 308c of the bearing sleeve 308. However, this should not be construed restrictively. For example, as illustrated in FIG. 23, while the lower end surface 310a1 of the disk portion 310a of the hub 310 is formed in a flat shape free from steps, the upper end surface 308c of the bearing sleeve 308 is provided above in the axial direction with respect to the upper end surface 309a of the housing 309, whereby the minute gap C can be formed between the lower end surface 310a1 of the disk portion 310a and the upper end surface 308c of the bearing sleeve 308. With this configuration, the gap width N of the minute gap C is set to be smaller than the gap width M of the thrust bearing gap Tₛ of the second thrust bearing portion T2.

Alternatively, as illustrated in FIGS. 24(a) and (b), it is possible to protrude upward a part of the upper end surface 308c of the bearing sleeve 308, and to form the minute gap C between the protruding portion 308c1 and the lower end surface 310a1 of the disk portion 310a of the hub 310. As in the above-mentioned embodiment, the gap width N of the minute gap C is also set to be smaller than the gap width M of the thrust bearing gap Tₛ. In this example, the protruding portion 308c1 is annularly formed at the center in the radial direction of the upper end surface 308c of the bearing sleeve 308. With this configuration, when compared with the case in which the entire of the upper end surface 308c of the bearing sleeve 308 is subjected to sliding contact at the time of low-speed rotation of the bearing device as in the above-mentioned embodiment, the area of the portion subjected to sliding contact is smaller. Therefore, rotational torque can be suppressed.

The configuration of the protruding portion 308c1 is not particularly limited. For example, as illustrated in FIG. 25, the protruding portion 308c1 may be formed in a radial pattern on the upper end surface 308c of the bearing sleeve 308. In this case, when the rotary-side member 303 is rotated, a dynamic pressure effect is generated not only in the lubricating oil in the thrust bearing gap Tₛ, but also in the lubricating oil in the minute gap C formed between the protruding portion 308c1 and the lower end surface 310a1 of the disk portion 310a of the hub 310. By the dynamic pressure, for example, the hub 310 is floated earlier at the time of activation of the bearing device. As a result, it is possible to reduce the sliding contact between the surfaces opposed to each other through an intermediation of the minute gap C.

Alternatively, as illustrated in FIG. 26, it is possible to protrude downward a part of the lower end surface 310a1 of the disk portion 310a of the hub 310, and to form the minute gap C between the protruding portion 310a13 and a part of the region of the upper end surface 308c of the bearing sleeve 308. As in the above-mentioned embodiment, the gap width N of the minute gap C is also set to be smaller than the gap width M of the thrust bearing gap Tₛ.

In addition, the structure of the fluid dynamic bearing device 301 is not limited to the above-mentioned one. For example, in the above-mentioned embodiment, while the thrust bearing portions are provided at two points, this should not be construed restrictively. For example, in a fluid dynamic bearing device 321 illustrated in FIG. 27, a thrust bearing portion T is provided at one point, that is, provided between the lower end surface 310a1 of the disk portion 310a of the hub 310 and the upper end surface 309a of the housing 309. Further, in the above-mentioned embodiment, the shaft member 302 is prevented from being detached by the flange portion 302b provided at the lower end of the shaft member 302. However, in this embodiment, a detachment stopping member 315 is fixed along the inner periphery of the hub 310, and the detachment stopping member 315 and the housing are engaged with each other in the axial direction. In this manner, the shaft member 302 and the hub 310 are prevented from being detached. The detachment stopping member 315 is formed, for example, in a substantially L-shaped cross-section by press working of a metal material, and is fixed to a step portion 310e provided at the upper end of the inner peripheral surface of the cylindrical portion 310b of the hub 310. The seal space S is formed between an inner peripheral surface 315a of the detachment stopping member 315 and the first tapered surface 309b in the upper portion of the outer peripheral surface of the housing 309 opposed thereto. The inner peripheral surface 315a is formed in a tapered shape gradually enlarged upward, and has the same function as that of the second tapered surface 310b1 of the above-mentioned embodiment.

Further, in the fluid dynamic bearing device 321, the hub 310 is formed by injection molding of a resin together with a core metal 313 as an inserted component. With this configuration, when compared with the case of being formed only of a resin as described above, the rigidity of the hub 310 can be increased. Further, the core metal 313 is faced with the minute gap C, whereby abrasion resistance of the portion subjected to sliding contact with the upper end surface 308c of the bearing sleeve 308 can be enhanced. The housing 309 is formed in a cup shape, and an inner bottom surface 309f thereof is provided with a radial groove 309f1. Through an intermediation of the radial groove 309f1 and the axial groove 308d1 provided in the outer peripheral surface 308d of the bearing sleeve 308, a gap between a lower end surface 302d of the shaft member 302 and the inner bottom surface 309f of the housing 309 and a gap between the lower end surface 310a1 of the disk portion 310a of the hub 310 and the upper end surface 308c of the bearing sleeve 308 are communicated with each other.

In the above-mentioned embodiment, while the hub 310 is formed of a resin or a resin including a core metal, this should not be construed restrictively. For example, the hub 310 may be formed of a metal material. Further, in the above-mentioned embodiment, while the bearing sleeve 308 is formed of a sintered metal, this should not construed restrictively. For example, the bearing sleeve 308 is formed of a porous resin.

Further, in the above-mentioned embodiment, while the side on which the shaft member 302 and the hub 310 are provided is represented as the rotary-side member, and the side on which the bearing sleeve 308 and the housing 309 are provided is represented as the fixed-side member, the rotary-side member and the fixed-side member may be set oppositely thereto.

In addition, as in the fluid dynamic bearing device 301 illustrated in FIG. 2, when the core metal 313 is exposed on the lower end surface 310a1 of the hub 310, the thrust dynamic pressure generating portion can be formed, for example, simultaneously with press working of the core metal 313. In particular, when the first end surface 310a11 and the second end surface 310a12 of the core metal 313 are separately pressed as described above, and the dynamic pressure generating portion is formed simultaneously with pressing of the first end surface 310a11, the dynamic pressure generating portion can be formed by pressing in a more restricted region. Therefore, the dynamic pressure generating portion can be formed with high accuracy.

In the following, a fourth embodiment of the present invention is described with reference to FIGS. 28 to 33.

FIG. 28 conceptually illustrates a construction example of a spindle motor for an information apparatus incorporating a fluid dynamic bearing device (fluid dynamic bearing device) 401 of the present invention. The spindle motor is used for a disk drive such as an HDD, and includes the fluid dynamic bearing device 401 for relatively rotating and supporting a shaft member 402 in a non-contact manner, a stator coil 404 and a rotor magnet 405 opposed to each other through an intermediation of, for example, a radial gap, and a bracket 406. The stator coil 404 is mounted to an inner peripheral surface on the outer peripheral surface side of the bracket 406, and the rotor magnet 405 is fixed to a yoke 412 provided on the radially outer side of a hub 410. The fluid dynamic bearing device 401 is fixed to the inner periphery of the bracket 406. Further, one or multiple disks as information recording media (not shown) are held on the hub 410. In the spindle motor constructed as described above, when the stator coil 404 is energized, the rotor magnet 405 is rotated with an excitation force generated between the stator coil 404 and the rotor magnet 405. In accordance therewith, the hub 410 and disks held on the hub 410 are integrally rotated with the shaft member 402.

FIG. 29 illustrate the fluid dynamic bearing device 401. This fluid dynamic bearing device 401 mainly includes the shaft member 402, the hub 410 protruding in the radially outward direction of the shaft member 402, a bearing sleeve 408 having the shaft member 402 inserted along the inner periphery thereof, a housing 409 for holding the bearing sleeve 408, and a lid member 411 for closing one end of the housing 409. Note that, for the sake of convenience in description, description is made as follows on the assumption that, of the opening portions of the housing 409, which are formed at both axial ends, the side on which the housing 409 is closed with the lid member 411 is a lower side, and the side opposite to the closed side is an upper side.

The radial bearing portions R1 and R2 are provided while being axially separated from each other between an outer peripheral surface 402a of the shaft member 402 and an inner peripheral surface 408a of the bearing sleeve 408. Further, the first thrust bearing portion T1 is provided between a lower end surface 408b of the bearing sleeve 408 and an upper end surface 402b1 of a flange portion 402b of the shaft member 402, and the second thrust bearing portion T2 is provided between an upper end surface 409a of the housing 409 and a lower end surface 410a1 of a disk portion 410a of the hub 410.

The bearing sleeve 408 is formed in a cylindrical shape with use of a porous body made of a sintered metal including, for example, copper as a main component. The bearing sleeve 408 is fixed to an inner peripheral surface 409c of the housing 409 by an appropriate means such as bonding (including loose bonding), press-fitting (including press-fit bonding), or adhesion (including ultrasonic adhesion). In this case, in order to prevent contact with the hub 410, the upper end surface 408c of the bearing sleeve 408 is arranged on the inner bearing side (lower side in the figure) with respect to the upper end surface 409a of the housing 409 in the axial direction.

As illustrated in FIG. 30, in the entire or a partially cylindrical region of the inner peripheral surface 408a of the bearing sleeve 408, regions where multiple dynamic pressure grooves 408a1 and 408a2 are arranged in a herringbone pattern are formed while being axially separated from each other. Further, as illustrated in FIG. 31, in the entire or a partially annular region of the lower end surface 408b of the bearing sleeve 408, there is formed a region where multiple dynamic pressure grooves 408b1 are arranged in a spiral pattern.

The housing 409 is formed in a substantially cylindrical shape with use of a metal material or a resin material so as to be opened at both axial ends thereof, with the opening portion on one end side being sealed with the lid member 411. As illustrated in FIG. 32, in the entire or a partially annular region of the upper end surface 409a of the housing 409, there is formed a region where multiple dynamic pressure grooves 409a1 are arranged in a spiral pattern. Along the upper outer periphery of the housing 409, there is formed a first tapered surface 409b gradually enlarged upward. Along the lower outer periphery of the housing 409, there is formed a cylindrical surface 409e. The cylindrical surface 409e is fixed along the inner periphery of the bracket 406 by means such as bonding, press-fitting, or adhesion. The lid member 411 for sealing the lower end side of the housing 409 is formed of a metal or a resin, and is fixed to a step portion 409d provided on the inner peripheral side of the lower end of the housing 409 by means such as bonding, press-fitting, or adhesion.

The shaft member 402 is formed of a metal, for example. At the lower end of the shaft member 402, the flange portion 402b is separately provided as a detachment stopper. The flange portion 402b is made of a metal, and fixed to the shaft member 402 by means such as screwing or bonding.

The hub 410 is formed by injection molding of a resin including a core metal 413, and configurationally includes the disk portion 410a for covering the upper opening portion of the housing 409, a cylindrical portion 410b extending axially downward from the outer peripheral portion of the disk portion 410a, and a brim portion 410c protruding to the radially outer side from the cylindrical portion 10b. The disks (not shown) are engaged along the outer periphery of the disk portion 410a, and placed onto a disk mounting surface 410d which is formed on the upper end surface of the brim portion 410c. Then, the disks are held on the hub 410 by an appropriate means (not shown) (such as clamper). As described above, the hub 410 made of a resin includes the core metal 413, whereby the strength of the hub 410 can be increased. As a result, it is possible to prevent deformation of the hub 410 due to a clamping force at the time of disk mounting.

When the inner space of the bearing device is filled with the lubricating oil described later, the lower end surface 410a1 of the disk portion 410a of the hub 410 is faced with the space filled with the lubricating oil. On the lower end surface 410a1 as an oil contact surface, there are formed a first end surface 410a11 in the outer peripheral portion thereof, and a second end surface 410a12 through an intermediation of an axial step on the radially inner side of the first end surface 410a11. The second end surface 410a12 is provided on the inner bearing side (lower side in the figure) with respect to the first end surface 410a11 in the axial direction. With this structure, when compared with the case of the conventional products in which the lower end surface 410a1 is formed in a flat shape free from steps (indicated by dotted line in FIG. 29(b)), the volume of the space formed between the hub 410 and the bearing sleeve 408 can be reduced. Therefore, it is possible to reduce the total amount of the lubricating oil filled in the bearing, and to reduce the thermal expansion amount of the lubricating oil. Thus, the capacity of the seal space S described later can be reduced, whereby the bearing device can be downsized.

On the lower end surface 410a1 of the disk portion 410a of the hub 410, there is exposed a lower end surface 413a of the core metal 413. The first end surface 410a11 formed on the lower end surface 410a1 is opposed to the upper end surface 409a of the housing 409 through an intermediation of the thrust bearing gap of the second thrust bearing portion T2. Thus, at the time of low-speed rotation, such as activation and stop of the bearing device, the first end surface 410a11 and the upper end surface 409a of the housing 409 are brought into sliding contact with each other. Accordingly, the first end surface 410a11 is necessary to have high abrasion resistance. In this embodiment, the first end surface 410a11 is formed of the core metal 413, and hence more excellent abrasion resistance can be obtained when compared with that of a resin.

As described above, the first end surface 410a11 and the second end surface 410a12 are formed on the lower end surface 413a of the core metal 413, whereby the thickness in the radially inner portion of the core metal 413 can be made larger than that of the radially outerportion. With this configuration, the fixation strength between the shaft member 402 and the core metal 413 is increased, whereby the strength of the hub 410 is enhanced.

The core metal 413 is formed, for example, by press working of stainless steel. In this case, while being able to be formed by single pressing, the core metal 413 can be formed by double pressing. Specifically, the entire of the core metal 413 is pressed by first pressing so as to be uniformly formed by the thickness of the second end surface 410a12. In this case, the lower end surface 413a of the core metal 413 is formed in a flat shape free from steps. After that, by second pressing, only the outer peripheral portion of the lower end surface 413a of the core metal 413 is pressed so as to form the first end surface 410a11. The second pressing is performed in a more restricted region than in the first pressing, and hence it is possible to perform working with high accuracy. Accordingly, the first end surface 410a11 faced with the thrust bearing gap can be worked with high accuracy, and hence the gap width of the thrust bearing gap is set with high accuracy. Thus, the supporting force in the thrust direction can be enhanced. Note that, in order to obtain the stable supporting force in the thrust direction, it is preferable that the flatness of the first end surface 410a11 be set to be equal to or smaller than 5 μm, or desirably, equal to or smaller than 2 μm.

The core metal 413 and the shaft member 402 are fixed to each other by being welded in a press-fitting state therebetween. The core metal 413 and the shaft member 402 are inserted and subjected to resin injection molding, whereby the resin portion 414 of the hub 410 is formed. The resin portion 414 is molded by injection molding of a resin composite which includes the following as a base resin, for example, a crystalline resin such as liquid crystal polymer (LCP), polyphenylene sulfide (PPS), and polyether ether ketone (PEEK), or an amorphous resin such as polyphenylsulfone (PPSU), polyethersulfone (PES), and polyetherimide (PEI). Further, fiber filler such as carbon fiber or glass fiber, whisker filler such as potassium titanate, scale-like filler such as mica, carbon black, black lead, carbon nano material, or fiber or powder conductive filler such as metal powders of various types can be used while being mixed by an appropriate amount with the above-mentioned base resin in accordance with purposes.

In the inner peripheral surface of the cylindrical portion 410b of the hub 410, on the portion opposed to the first tapered surface 409b provided to the outer peripheral upper end of the housing 409, there is formed a second tapered surface 410b1 which is enlarged upward. A taper angle of the second tapered surface 410b1 with respect to the axial direction is set to be smaller than a taper angle of the first tapered surface 409b. With this configuration, a tapered seal space S is formed between the first tapered surface 409b and the second tapered surface 410b1, with the radial dimension thereof being gradually decreased upward. When the hub 410 (shaft member 402) is rotated, the seal space S is communicated with the radially outer side of the thrust bearing gap of the thrust bearing portion T2. In a state of being filled in the fluid dynamic bearing device 401, the lubricating oil described later is drawn to the narrower side of the seal space S by a capillary force. As a result, the oil surface thereof is constantly retained within the range of the seal space S. Further, the outer peripheral portion of the seal space S is defined by the second tapered surface 410b1, and hence the lubricating oil is pressed upward by the tapered surface 410b1 when a radial centrifugal force is applied to the lubricating oil in the seal space S. Therefore, the lubricating oil can be more reliably retained inside the seal space S.

In the fluid dynamic bearing device 401, for example, the lubricating oil is filled as a lubricating fluid. Examples of the lubricating oil include ones of various types. As a lubricating oil provided to the fluid dynamic bearing device for a disk drive such as an HDD, in consideration of changes in temperature during use and transportation thereof, it is possible to suitably use an ester-based lubricating oil superior in low evaporation rate and low viscosity, for example, a lubricating oil including dioctyl sebacate (DOS) or dioctyl azelate (DOZ) as a base oil.

In the fluid dynamic bearing device 401 constructed as described above, when the shaft member 402 is rotated, the radial bearing gaps are formed between the regions where the dynamic pressure grooves 408a1 and 408a2 formed in the inner peripheral surface 408a of the bearing sleeve 408 are formed and the outer peripheral surface 402a of the shaft member 402 opposed thereto. Then, in accordance with the rotation of the shaft member 402, the lubricating oil in the radial bearing gaps is pressed to the central side in the axial direction of the dynamic pressure grooves 408a1 and 408a2, and the pressure thereof is increased. As described above, owing to the dynamic pressure effect of the lubricating oil, which is generated by the dynamic pressure grooves 408a1 and 408a2 respectively provided in the first radial bearing portion R1 and the second radial bearing portion R2, the shaft member 402 is supported in the radial direction in a non-contact manner.

Simultaneously, the pressure of the lubricating oil film formed in the thrust bearing gap between the region which is formed in the lower end surface 408b of the bearing sleeve 408, where the dynamic pressure grooves 408b1 are formed, and the upper end surface 402b1 of the flange portion 402b opposed thereto, and of the lubricating oil film formed in the thrust bearing gap between the region which is formed in the upper end surface 409a of the housing 409, where the dynamic pressure grooves 409a1 are formed, and the lower end surface 410a1 of the hub 410 opposed thereto, is increased by the dynamic pressure effect of the dynamic pressure grooves 408b1 and 409a1 respectively formed in the first thrust bearing portion T1 and the second thrust bearing portion T2. Then, by the pressure of those oil films, the shaft member 402 and the hub 410 are supported in the thrust direction in a non-contact manner.

Further, in this embodiment, an axial groove 408d1 is formed in an outer peripheral surface 408d of the bearing sleeve 408. With this configuration, the lubricating oil filled inside the bearing can be circulated, and hence it is possible to prevent generation of bubbles involved in local generation of negative pressure, and the like. Specifically, it is possible to circulate the lubricating oils filled in the gap between the lower end surface 410a1 of the disk portion 410a of the hub 410 and an upper end surface 408c of the bearing sleeve 408, the bearing gaps of the first and second radial bearing portions R1 and R2, and the bearing gap of the first thrust bearing portion T1. In this embodiment, the dynamic pressure grooves 408a1 formed in the inner peripheral surface 408a of the bearing sleeve 408 are formed asymmetrically in the axial direction so as to press downward the lubricating oil in the bearing gap of the first radial bearing portion R1, whereby the lubricating oil inside the bearing is forcibly circulated (refer to FIG. 30). When the forcible circulation as described above is not particularly necessary, the dynamic pressure grooves 408a1 may be formed symmetrically in the axial direction.

The present invention is not limited to the above-mentioned embodiment. Other embodiments of the present invention are described in the following. Note that, in the following description, the parts having the same structures and functions as those in above-mentioned embodiment are denoted by the same reference symbols, and description thereof is omitted.

In the above-mentioned embodiment, while the shaft member 402 is prevented from being detached by the flange portion 402b provided at the lower end of the shaft member 402, this should not be construed restrictively. For example, in the fluid dynamic bearing device 421 illustrated in FIG. 33, a detachment stopping member 415 is fixed along the inner periphery of the hub 410, and the detachment stopping member 415 and the housing are engaged with each other in the axial direction. In this manner, the shaft member 402 and the hub 410 are prevented from being detached. The detachment stopping member 415 is formed, for example, in a substantially L-shaped cross-section by press working of a metal material, and is fixed to a step portion 410e provided at the upper end of the inner peripheral surface of the cylindrical portion 410b of the hub 410. The seal space S is formed between an inner peripheral surface 415a of the detachment stopping member 415 and the first tapered surface 409b in the upper portion of the outer peripheral surface of the housing 409 opposed thereto. The inner peripheral surface 415a is formed in a tapered shape gradually enlarged upward, and has the same function as that of the second tapered surface 410b1 of the above-mentioned embodiment.

In the fluid dynamic bearing device 421, the thrust bearing portion T is provided at one point, that is, provided between the lower end surface 410a1 of the disk portion 410a of the hub 410 and the upper end surface 409a of the housing 409. The housing 409 is formed in a cup shape, and an inner bottom surface 409f thereof is provided with a radial groove 409f1. Through an intermediation of the radial groove 409f1 and the axial groove 408d1 provided in the outer peripheral surface 408d of the bearing sleeve 408, a gap between a lower end surface 402c of the shaft member 402 and the inner bottom surface 409f of the housing 409 and a gap between the lower end surface 410a1 of the disk portion 410a of the hub 410 and the upper end surface 408c of the bearing sleeve 408 are communicated with each other.

Further, in the above-mentioned embodiment, while the hub 410 is formed by injection molding of a resin together with the core metal 413 as an inserted component, this should not be construed restrictively. For example, the entire of the hub 410 can be made of a metal material or a resin material.

In the following, a fifth embodiment of the present invention is described with reference to FIGS. 34 to 41.

FIG. 34 conceptually illustrates a construction example of a spindle motor for an information apparatus incorporating a fluid dynamic bearing device 501 of the present invention. The spindle motor is used for a disk drive such as an HDD, and includes the fluid dynamic bearing device (fluid dynamic bearing device) 501 for relatively rotating and supporting a shaft member 502 in a non-contact manner, a stator coil 504 and a rotor magnet 505 opposed to each other through an intermediation of, for example, a radial gap, and a bracket 506. The stator coil 504 is mounted to an inner peripheral surface on the outer peripheral side of the bracket 506, and the rotor magnet 505 is fixed to a yoke 512 provided on the radially outer side of a hub 510. The fluid dynamic bearing device 501 is fixed to the inner periphery of the bracket 506. Further, one or multiple disks as information recording media (not shown) are held on the hub 510. In the spindle motor constructed as described above, when the stator coil 504 is energized, the rotor magnet 505 is rotated with an excitation force generated between the stator coil 504 and the rotor magnet 505. In accordance therewith, the hub 510 and disks held on the hub 510 are integrally rotated with the shaft member 502.

FIG. 35 illustrates the fluid dynamic bearing device 501. This fluid dynamic bearing device 501 mainly includes the shaft member 502, the hub 510 protruding in the radially outward direction of the shaft member 502, a bearing sleeve 508 having the shaft member 502 inserted along the inner periphery thereof, a housing 509 for holding the bearing sleeve 508, and a lid member 511 for closing one end of the housing 509. Note that, for the sake of convenience in description, description is made as follows on the assumption that, of the opening portions of the housing 509, which are formed at both axial ends, the side on which the housing 509 is closed with the lid member 511 is a lower side, and the side opposite to the closed side is an upper side.

In the fluid dynamic bearing device 501, the radial bearing portions R1 and R2 are provided while being axially separated from each other between an outer peripheral surface 502a of the shaft member 502 and an inner peripheral surface 508a of the bearing sleeve 508. Further, the first thrust bearing portion T1 is provided between a lower end surface 508b of the bearing sleeve 508 and an upper end surface 502b1 of a flange portion 502b of the shaft member 502, and the second thrust bearing portion T2 is provided between an upper end surface 509a of the housing 509 and a lower end surface 510a1 of a disk portion 510a of the hub 510.

The bearing sleeve 508 is formed in a cylindrical shape with use of a porous body made of a sintered metal including, for example, copper as a main component. The bearing sleeve 508 is fixed to an inner peripheral surface 509c of the housing 509 by an appropriate means such as bonding, press-fitting (including press-fit bonding), adhesion (including ultrasonic adhesion), or welding (including laser welding).

As illustrated in FIG. 36, in the entire or a partially cylindrical region of the inner peripheral surface 508a of the bearing sleeve 508, regions where multiple dynamic pressure grooves 508a1 and 508a2 are arranged in a herringbone pattern are formed while being axially separated from each other. Further, as illustrated in FIG. 37, in the entire or a partially annular region of the lower end surface 508b of the bearing sleeve 508, there is formed a region where multiple dynamic pressure grooves 508b1 are arranged in a spiral pattern.

The housing 509 is formed in a substantially cylindrical shape with use of a metal material or a resin material so as to be opened at both axial ends thereof, with the opening portion on one end side being sealed with the lid member 511. As illustrated in FIG. 38, in the entire or a partially annular region of the upper end surface 509a of the housing 509, there is formed a region where multiple dynamic pressure grooves 509a1 are arranged in a spiral pattern. Along the upper outer periphery of the housing 509, there is formed a first tapered surface 509b gradually enlarged upward. Along the lower outer periphery of the housing 509, there is formed a cylindrical surface 509e. The cylindrical surface 509e is fixed along the inner periphery of the bracket 506 by means such as bonding, press-fitting, adhesion, or welding. The lid member 511 for sealing the lower end side of the housing 509 is made of a metal or a resin, and is fixed to a step portion 509d provided on the inner peripheral side of the lower end of the housing 509 by means such as bonding, press-fitting, adhesion, or welding.

The shaft member 502 is made of a metal, for example. At the lower end of the shaft member 502, the flange portion 502b is separately provided as a detachment stopper. The flange portion 502b is made of a metal, and fixed to the shaft member 502 by means such as screwing or bonding.

The hub 510 is constituted by a core metal 513 as a metal portion and a resin portion 514, and configurationally includes the disk portion 510a for covering the upper opening portion of the housing 509, a cylindrical portion 510b extending axially downward from the outer peripheral portion of the disk portion 510a, and a brim portion 510c protruding to the radially outer side from the cylindrical portion 510b. The disks (not shown) are engaged along the outer periphery of the disk portion 510a, and placed onto a disk mounting surface 510d which is formed on the upper end surface of the brim portion 510c. Then, the disks are held on the hub 510 by an appropriate holding means (not shown) (such as clamper). As described above, the hub 510 made of a resin includes the core metal 513, whereby the strength of the hub 510 can be increased. As a result, it is possible to prevent deformation of the hub 510 due to a clamping force at the time of disk mounting.

The lower end surface 510a1 of the disk portion 510a of the hub 510 is opposed to a region of the upper end surface 509a of the housing 509, where the dynamic pressure grooves are formed, through an intermediation of the thrust bearing gap. Those surfaces are brought into sliding contact with each other at the time of low-speed rotation, such as activation and stop of the bearing device, and hence are necessary to have high abrasion resistance. In this embodiment, the core metal 513 is exposed on the lower end surface 510a1 of the disk portion 510a of the hub 510, whereby higher abrasion resistance can be achieved when compared with that of a resin.

The core metal 513 is formed substantially in a disk-like shape, for example, by plastic working of stainless steel (press working, for example). As illustrated in FIG. 39, an inner peripheral surface 513a of the core metal 513 is fixed to the outer peripheral surface 502a of the shaft member 502. Specifically, the shaft member 502 is press-fitted (including light press-fitting) to the inner peripheral surface 513a of the core metal 513, and the engaged surface is welded, whereby both the surfaces are fixed to each other. In this case, the inner peripheral surface 513a of the core metal 513, which serves as a fixed surface, is formed as a concave-convex surface. In this embodiment, multiple axial recessed portions 513a1 are formed in a stepped configuration, whereby peripheral concaves and convexes are formed in the inner peripheral surface 513a. The recessed portions 513a1 can be formed simultaneously with press working of the core metal 513.

As described above, the recessed portions 513a1 are provided in the inner peripheral surface 513a of the core metal 513, whereby, when the shaft member 502 is press-fitted to the inner peripheral surface 513a of the core metal 513, the press-fitting area between the core metal 513 and the shaft member 502 can be reduced. With this configuration, it is possible to mitigate press-fitting resistance, to thereby prevent deformation of the core metal 513. In particular, as in this embodiment, with the configuration in which the recessed portions 513a1 are provided in the axial direction and the concaves and convexes are formed in the circumferential direction, it is possible to increase the strength against axial resistance at the time of press-fitting.

Further, the recessed portions 513a1 are provided in the inner peripheral surface 513a of the core metal 513, whereby, when the core metal 513 and the shaft member 502 are welded to each other, the gap between the recessed portions 513a1 of inner peripheral surface 513a of the core metal 513 and the outer peripheral surface 502a of the shaft member 502 can be filled with the liquated material . As a result, it is possible to prevent the failure caused by the liquated material flowing into the other portions.

The core metal 513 and the shaft member 502 fixed as described above are inserted and subjected to resin injection molding, whereby the resin portion 514 of the hub 510 is formed. The resin portion 514 is molded by injection molding of a resin composite which includes the following as a base resin, for example, a crystalline resin such as liquid crystal polymer (LCP), polyphenylene sulfide (PPS), and polyether ether ketone (PEEK), or an amorphous resin such as polyphenylsulfone (PPSU), polyethersulfone (PES), and polyetherimide (PEI). Further, fiber filler such as carbon fiber or glass fiber, whisker filler such as potassium titanate, scale-like filler such as mica, carbon black, black lead, carbon nano material, or fiber or powder conductive filler such as metal powders of various types can be used while being mixed by an appropriate amount with the above-mentioned base resin in accordance with purposes.

In this case, the recessed portions 513a1 are formed in the inner peripheral surface 513a of the core metal 513, thereby forming gaps together with the outer peripheral surface 502a of the shaft member 502 therebetween. The boundary surface between the shaft member 502 and the hub 510 is opened to the atmosphere at one end thereof, and is faced with the space inside the bearing, which is filled with the lubricating oil, at the other end thereof. Thus, there is a risk that the lubricating oil leaks out through the gaps. As described above, a resin is injection-molded together with the shaft member 502 and the core metal 513 fixed to the shaft member 502 as inserted components, whereby the injected resin flows into the gaps between the shaft member 502 and the core metal 513 so as to fill the gaps. As a result, it is possible to prevent the leakage of the lubricating oil through the gaps.

In the inner peripheral surface of the cylindrical portion 510b, a second tapered surface 510b1 enlarged upward is formed in the portion opposed to the first tapered surface 509b provided at the outer peripheral upper end of the housing 509. A taper angle of the second tapered surface 510b1 with respect to the axial direction is set to be smaller than a taper angle of the first tapered surface 509b. With this configuration, the tapered seal space S is formed between the first tapered surface 509b and the second tapered surface 510b1, with the radial dimension thereof being gradually decreased upward. When the hub 510 (shaft member 502) is rotated, the seal space S is communicated with the radially outer side of the thrust bearing gap of the thrust bearing portion T2. In a state of being filled in the fluid dynamic bearing device 501, the lubricating oil described later is drawn to the narrower side of the seal space S by a capillary force. As a result, the oil surface thereof is constantly retained within the range of the seal space S. Further, the outer peripheral portion of the seal space S is defined by the second tapered surface 510b1, and hence the lubricating oil is pressed upward by the tapered surface 510b1 when a centrifugal force is applied to the lubricating oil in the seal space S. Therefore, the lubricating oil can be more reliably retained inside the seal space S.

In an upper end surface 510a2 of the disk portion 510a of the hub 510, a clamping hole 510a20 is provided. When the clamper is screwed to the upper end portion of the shaft member 502 for the purpose of fixing the disks to the disk mounting surface 510d, a jig is inserted into the clamping hole 510a20, whereby the hub 510 is prevented from being rotated. As long as being provided in the upper end surface 510a2 of the disk portion 510a of the hub 510, the clamping hole 510a20 is not restricted in formation portion and number, for example, equiangularly provided at three portions. The clamping hole 510a20 is formed, for example, by machining or die molding simultaneously with injection molding of the resin portion 514.

In the fluid dynamic bearing device 501, for example, a lubricating oil is filled as a lubricating fluid. Specifically, of the space formed between the shaft member 502 and the hub 510, and the bearing sleeve 508, the housing 509, and the lid member 511, the whole space on the inner bearing side with respect to the seal space S is filled with the lubricating oil. In this case, the oil surface is retained within the seal space S. Examples of the lubricating oil include ones of various types. As a lubricating oil provided to the fluid dynamic bearing device for a disk drive such as an HDD, in consideration of changes in temperature during use and transportation thereof, it is possible to suitably use an ester-based lubricating oil superior in low evaporation rate and low viscosity as a base oil, for example, a lubricating oil using dioctyl sebacate (DOS) or dioctyl azelate (DOZ).

In the fluid dynamic bearing device 501 constructed as described above, when the shaft member 502 is rotated, the radial bearing gaps are formed between the regions where the dynamic pressure grooves 508a1 and 508a2 formed in the inner peripheral surface 508a of the bearing sleeve 508 are formed and the outer peripheral surface 502a of the shaft member 502 opposed thereto. Then, in accordance with the rotation of the shaft member 502, the lubricating oil in the radial bearing gaps are pressed to the central side in the axial direction of the dynamic pressure grooves 508a1 and 508a2, and the pressure thereof is increased. As described above, owing to the dynamic pressure effect of the lubricating oil, which is generated by the dynamic pressure grooves 508a1 and 508a2 respectively provided in the first radial bearing portion R1 and the second radial bearing portion R2, the shaft member 502 is supported in the radial direction in a non-contact manner.

Simultaneously, between a region where the dynamic pressure grooves 508b1 of the lower end surface 508b of the bearing sleeve 508 are formed and the upper end surface 502b1 of the flange portion 502b, and between a region where the dynamic pressure grooves 509a1 of the upper end surface 509a of the housing 509 are formed and the lower end surface 510a1 of the hub 510, the thrust bearing gaps are respectively formed. The pressure of the lubricating oil film formed in those thrust bearing gaps is increased by the dynamic pressure effect of the dynamic pressure grooves 508b1 and 509a1 respectively formed in the first thrust bearing portion T1 and the second thrust bearing portion T2. As a result, the shaft member 502 and the hub 510 are supported in the thrust direction in a non-contact manner.

Further, in this embodiment, an axial groove 508d1 is formed in an outer peripheral surface 508d of the bearing sleeve 508. With this configuration, the lubricating oil filled inside the bearing can be circulated, and hence it is possible to prevent generation of bubbles involved in local generation of negative pressure. Specifically, it is possible to circulate the lubricating oils filled in the gap between the lower end surface 510a1 of the disk portion 510a of the hub 510 and an upper end surface 508c of the bearing sleeve 508, the bearing gaps of the first and second radial bearing portions R1 and R2, and the bearing gap of the first thrust bearing portion T1. In this embodiment, the dynamic pressure grooves 508a1 formed in the inner peripheral surface 508a of the bearing sleeve 508 are formed asymmetrically in the axial direction so as to press downward the lubricating oil in the bearing gap of the first radial bearing portion R1, whereby the lubricating oil inside the bearing is forcibly circulated (refer to FIG. 36). When the forcible circulation as described above is not particularly necessary, the dynamic pressure grooves 508a1 may be formed symmetrically in the axial direction.

The present invention is not limited to the above-mentioned embodiment. Other embodiments of the present invention are described in the following. Note that, in the following description, the parts having the same structures and functions as those in above-mentioned embodiment are denoted by the same reference symbols, and description thereof is omitted.

In the above-mentioned embodiment, in the fixation surfaces of the shaft member 502 and the core metal 513, the axial recessed portions 513a1 are provided in the inner peripheral surface 513a of the core metal 513, and the surface is formed as a concave-convex surface. However, this should not be construed restrictively. For example, conversely, it is possible to form the inner peripheral surface 513a of the core metal 513 as a cylindrical surface, and to provide recessed portions 502a1 in the portion of the outer peripheral surface 502a of the shaft member 502, which constitutes the fixation surface to the core metal 513, so as to form the portion as a concave-convex surface (FIG. 40). Alternatively, it is possible to form the fixation surfaces of both the shaft member 502 and the core metal 513 as concave-convex surfaces (not shown). In this case, through engagement in the circumferential direction, the concaves and convexes of the fixation surfaces opposed to each other can function as a relative rotation stopper between the shaft member 502 and the core metal 513. Further, the shape of those recessed portions 513a1 and 502a1 are not limited to a rectangular cross-section as illustrated in FIGS. 39 and 40. A triangular cross-section, a semi-circular cross-section, or a corrugated cross-section may be adopted. In addition, while being provided in the axial direction as described above, the recessed portions 513a1 and 502a1 are not limited thereto, and may be provided in a dotted pattern, a spiral pattern, or a knurled pattern.

Further, in the above-mentioned embodiment, while the shaft member 502 is prevented from being detached by the flange portion 502b provided at the lower end of the shaft member 502, this should not be construed restrictively. For example, in the fluid dynamic bearing device 521 illustrated in FIG. 41, a detachment stopping member 515 is fixed along the inner periphery of the hub 510, and the detachment stopping member 515 and the housing are engaged with each other in the axial direction. In this manner, the shaft member 502 and the hub 510 are prevented from being detached. The detachment stopping member 515 is formed, for example, in a substantially L-shaped cross-section by press working of a metal material, and is fixed to a step portion 510e provided at the upper end of the inner peripheral surface of the cylindrical portion 510b of the hub 510 . The seal space S is formed between an inner peripheral surface 515a of the detachment stopping member 515 and the first tapered surface 509b in the upper portion of the outer peripheral surface of the housing 509 opposed thereto. The inner peripheral surface 515a is formed in a tapered shape gradually enlarged upward, and has the same function as that of the second tapered surface 510b1 of the above-mentioned embodiment.

In the fluid dynamic bearing device 521, a thrust bearing portion is provided only at one point. Specifically, the thrust bearing portion T is provided between the lower end surface 510a1 of the disk portion 510a of the hub 510 and the upper end surface 509a of the housing 509. The housing 509 is formed in a cup shape, and an inner bottom surface 509f thereof is provided with a radial groove 509f1. Through an intermediation of the radial groove 509f1 and the axial groove 508d1 provided in the outer peripheral surface 508d of the bearing sleeve 508, a gap between a lower end surface 502c of the shaft member 502 and the inner bottom surface 509f of the housing 509 and a gap between the lower end surface 510a1 of the disk portion 510a of the hub 510 and the upper end surface 508c of the bearing sleeve 508 are communicated with each other.

In the following, a sixth embodiment of the present invention is described with reference to FIGS. 42 to 49.

FIG. 42 conceptually illustrates a construction example of a spindle motor for an information apparatus incorporating a fluid dynamic bearing device 601 of the present invention. The spindle motor is used for a disk drive such as an HDD, and includes the fluid dynamic bearing device (fluid dynamic bearing device) 601 for relatively rotating and supporting a shaft member 602 and a hub 610 in a non-contact manner, a stator coil 604 and a rotor magnet 605 opposed to each other through an intermediation of, for example, a radial gap, and a bracket 606. The stator coil 604 is mounted to an inner peripheral surface on the radially outer side of the bracket 606, and the rotor magnet 605 is fixed to a yoke 612 provided on the radially outer side of the hub 610. The fluid dynamic bearing device 601 is fixed to the inner periphery of the bracket 606. Further, a disk D as an information recording medium is fixed to the hub 610 with use of a clamper 603. In the spindle motor constructed as described above, when the stator coil 604 is energized, the rotor magnet 605 is rotated with an excitation force generated between the stator coil 604 and the rotor magnet 605. In accordance therewith, the hub 610 and the disk D held on the hub 610 are integrally rotated with the shaft member 602. Note that, in FIG. 43, while one disk D is fixed to the hub 610, this should not be construed restrictively. Multiple disks D may be fixed in some cases.

FIG. 43 illustrates the fluid dynamic bearing device 601. This fluid dynamic bearing device 601 mainly includes the shaft member 602, the hub 610 protruding in the radially outward direction of the shaft member 602, a bearing sleeve 608 having the shaft member 602 inserted along the inner periphery thereof, a housing 609 for holding the bearing sleeve 608 along the inner periphery thereof, and a lid member 611 for closing one end of the housing 609. Note that, for the sake of convenience in description, description is made as follows on the assumption that, of the opening portions of the housing 609, which are formed at both axial ends, the side on which the housing 609 is closed with the lid member 611 is a lower side, and the side opposite to the closed side is an upper side.

In the fluid dynamic bearing device 601, the radial bearing portions R1 and R2 are provided while being axially separated from each other between an outer peripheral surface 602a of the shaft member 602 and an inner peripheral surface 608a of the bearing sleeve 608. Further, the first thrust bearing portion T1 is provided between a lower end surface 608b of the bearing sleeve 608 and an upper end surface 602b1 of a flange portion 602b of the shaft member 602, and the second thrust bearing portion T2 is provided between an upper end surface 609a of the housing 609 and a lower end surface 610a1 of a disk portion 610a of the hub 610.

The bearing sleeve 608 is formed in a cylindrical shape with use of a porous body made of a sintered metal including, for example, copper as a main component. The bearing sleeve 608 is fixed to an inner peripheral surface 609c of the housing 609 by an appropriate means such as bonding (including loose bonding), press-fitting (including press-fit bonding), or adhesion (including ultrasonic adhesion).

As illustrated in FIG. 44, in the entire or a partially cylindrical region of the inner peripheral surface 608a of the bearing sleeve 608, regions where multiple dynamic pressure grooves 608a1 and 608a2 are arranged in a herringbone pattern are formed while being axially separated from each other. Further, as illustrated in FIG. 45, in the entire or a partially annular region of the lower end surface 608b of the bearing sleeve 608, there is formed a region where multiple dynamic pressure grooves 608b1 are arranged in a spiral pattern.

The housing 609 is formed in a substantially cylindrical shape with use of a metal material or a resin material so as to be opened at both axial ends thereof, with the opening portion on one end side being sealed with the lid member 611. As illustrated in FIG. 46, in the entire or a partially annular region of the upper end surface 609a of the housing 609, there is formed a region where multiple dynamic pressure grooves 609a1 are arranged in a spiral pattern. Along the upper outer periphery of the housing 609, there is formed a first tapered surface 609b gradually enlarged upward. Along the lower outer periphery of the housing 609, there is formed a cylindrical surface 609e. The cylindrical surface 609e is fixed along the inner periphery of the bracket 606 by means such as bonding, press-fitting, or adhesion. The lid member 611 for sealing the lower end side of the housing 609 is made of a metal or a resin, and is fixed to a step portion 609d provided on the inner peripheral side of the lower end of the housing 609 by means such as bonding, press-fitting, adhesion, or welding.

The shaft member 602 is formed of a metal, for example. At the lower end of the shaft member 602, the flange portion 602b is separately provided as a detachment stopper. The flange portion 602b is made of a metal, and fixed to the shaft member 602 by means such as screwing or bonding. The hub 610 is provided at the upper end of the shaft member 602, with the boundary surface therebetween being faced with the space inside the bearing at one end thereof, which is filled with the lubricating oil, and the other end being opened to the atmosphere.

The hub 610 is constituted by a core metal 613 as a metal portion and a resin molding portion 614, and configurationally includes the disk portion 610a for covering the upper opening portion of the housing 609, a cylindrical portion 610b extending axially downward from the outer peripheral portion of the disk portion 610a, and a brim portion 610c protruding to the radially outer side from the cylindrical portion 610b. On the upper end surface of the brim portion 610c, there is formed a disk mounting surface 610d, and in an upper end surface 610a2 of the disk portion 610a, there is formed a rotation stopping hole 610a20 for allowing mounting of a clamper 613 described later. As long as being provided on the upper end surface 610a2, the rotation stopping hole 610a20 is not restricted in formation portion and number, for example, equiangularly provided at three portions of the center in the radial direction of the upper end surface 610a2.

The disk D is fixed to the hub 610. Specifically, the disk D is engaged along the outer periphery of the disk portion 610a so as to be placed onto the disk mounting surface 610d, and the clamper 603 placed thereon is screwed into the screw hole provided in the upper end portion of the shaft member 602 with use of a screw 607. In this manner, the disk D is fixed thereto. In this case, a jig G indicated by a dotted line in FIG. 2 is inserted, through an intermediation of a through-hole 603a formed in the clamper 603, into the rotation stopping hole 610a20 provided to the hub 610. With this structure, the relative rotation between the clamper 603 and the hub 610 is regulated, and hence the screw 607 can be reliably screwed. Further, as described above, the hub 610 includes the core metal 613, whereby the strength of the hub 610 can be increased. As a result, it is possible to prevent deformation of the hub 610 due to a clamping force of the clamper 603.

The lower end surface 610a1 of the disk portion 610a of the hub 610 is opposed to a region of the upper end surface 609a of the housing 609, where the dynamic pressure grooves are formed, through an intermediation of a thrust bearing gap. Those surfaces are brought into sliding contact with each other at the time of low-speed rotation, such as activation and stop of the bearing device, and hence are necessary to have high abrasion resistance. In this embodiment, the core metal 613 is exposed on the lower end surface 610a1 of the disk portion 610a of the hub 610, whereby higher abrasion resistance can be achieved when compared with that of a resin.

In the portion of the inner peripheral surface of the cylindrical portion 610b, which is opposed to the first tapered surface 609b provided to the outer peripheral upper end of the housing 609, there is formed a second tapered surface 610b1 which is enlarged upward. A taper angle of the second tapered surface 610b1 with respect to the axial direction is set to be smaller than a taper angle of the first tapered surface 609b. With this configuration, the tapered seal space S is formed between the first tapered surface 609b and the second tapered surface 610b1, with the radial dimension thereof being gradually decreased upward. When the hub 610 (shaft member 602) is rotated, the seal space S is communicated with the radially outer side of the thrust bearing gap of the thrust bearing portion T2. In a state of being filled in the fluid dynamic bearing device 601, the lubricating oil described later is drawn to the narrower side of the seal space S by a capillary force. As a result, the oil surface thereof is constantly retained within the range of the seal space S. Further, the outer peripheral portion of the seal space S is defined by the second tapered surface 610b1, and hence the lubricating oil is pressed upward by the tapered surface 610b1 when a centrifugal force is applied to the lubricating oil in the seal space S. Therefore, the lubricating oil can be more reliably retained inside the seal space S.

In the fluid dynamic bearing device 601 having the structure as described above, for example, a lubricating oil is filled as a lubricating fluid. Specifically, the whole space on the inner bearing side with respect to the seal space S is filled with the lubricating oil, and the oil surface thereof is constrantly retained within the seal space S. Examples of the lubricating oil include ones of various types. As a lubricating oil provided to the fluid dynamic bearing device for a disk drive such as an HDD, in consideration of changes in temperature during use and transportation thereof, it is possible to suitably use an ester-based lubricating oil superior in low evaporation rate and low viscosity, for example, a lubricating oil using dioctyl sebacate (DOS) or dioctyl azelate (DOZ) as a base oil.

In the fluid dynamic bearing device 601 constructed as described above, when the shaft member 602 is rotated, the radial bearing gaps are formed between the regions where the dynamic pressure grooves 608a1 and 608a2 formed in the inner peripheral surface 608a of the bearing sleeve 608 are formed and the outer peripheral surface 602a of the shaft member 602 opposed thereto. Then, in accordance with the rotation of the shaft member 602, the lubricating oil in the radial bearing gaps are pressed to the central side in the axial direction of the dynamic pressure grooves 608a1 and 608a2, and the pressure thereof is increased. As described above, owing to the dynamic pressure effect of the lubricating oil, which is generated by the dynamic pressure grooves 608a1 and 608a2 respectively formed in the radial bearing portions R1 and R2, the shaft member 602 is supported in the radial direction in a non-contact manner.

Simultaneously, between a region where the dynamic pressure grooves 608b1 of the lower end surface 608b of the bearing sleeve 608 are formed and the upper end surface 602b1 of the flange portion 602b, and between a region where the dynamic pressure grooves 609a1 of the upper end surface 609a of the housing 609 are formed and the lower end surface 610a1 of the hub 610, the thrust bearing gaps are respectively formed. The pressure of the lubricating oil film formed in those thrust bearing gaps is increased by the dynamic pressure effect of the dynamic pressure grooves 608b1 and 609a1 respectively formed in the first thrust bearing portion T1 and the second thrust bearing portion T2. As a result, the shaft member 602 and the hub 610 are supported in both the thrust directions in a non-contact manner.

Further, in this embodiment, an axial groove 608d1 is formed in an outer peripheral surface 608d of the bearing sleeve 608. With this configuration, the lubricating oil filled inside the bearing can be circulated, and hence it is possible to prevent generation of bubbles involved in local generation of negative pressure. Specifically, it is possible to circulate the lubricating oils filled in the gap between the lower end surface 610a1 of the disk portion 610a of the hub 610 and an upper end surface 608c of the bearing sleeve 608, the bearing gaps of the first and second radial bearing portions R1 and R2, and the bearing gap of the first thrust bearing portion T1. In this embodiment, the dynamic pressure grooves 608a1 formed in the inner peripheral surface 608a of the bearing sleeve 608 are formed asymmetrically in the axial direction. Specifically, as illustrated in FIG. 44, of the dynamic pressure grooves 608a1, the upper grooves with respect to the annular smooth portion formed in the axial intermediate portion are formed to be longer than the lower grooves with respect thereto. With this configuration, when the shaft member 602 is rotated, the lubricating oil in the radial bearing gap of the first radial bearing portion R1 is pressed downward, whereby the lubricating oil inside the bearing can be forcibly circulated. Note that, when the forcible circulation as described above is not particularly necessary, the dynamic pressure grooves 608a1 may be formed symmetrically in the axial direction.

In the following, the forming process of the hub 610 is described with reference to FIG. 47.

The core metal 613 arranged in the hub 610 is formed in a substantially disk-like shape, for example, by plastic working of stainless steel (press working, for example). An inner peripheral surface 613a of the core metal 613 is fixed to the outer peripheral surface 602a of the shaft member 602 (refer to FIG. 47(a)). Specifically, the inner peripheral surface 613a of the core metal 613 is engaged with the shaft member 602 in a press-fitting manner, and the shaft member 602 and the inner peripheral surface 613a are fixed by welding the engagement surface therebetween.

The core metal 613 and the shaft member 602 fixed as described above are inserted and subjected to resin injection molding, whereby the resin molding portion 614 of the hub 610 is formed. The resin molding portion 614 is molded by injection molding of a resin composite which includes the following as a base resin, for example, a crystalline resin such as liquid crystal polymer (LCP), polyphenylene sulfide (PPS), and polyether ether ketone (PEEK), or an amorphous resin such as polyphenylsulfone (PPSU), polyethersulfone (PES), and polyetherimide (PEI). Further, fiber filler such as carbon fiber or glass fiber, whisker filler such as potassium titanate, scale-like filler such as mica, carbon black, black lead, carbon nano material, or fiber or powder conductive filler such as metal powders of various types can be used while being mixed by an appropriate amount with the above-mentioned base resin in accordance with purposes.

FIG. 47(a) illustrates a molding die for forming the resin molding portion 614. The die is constituted by a movable die 621 and a fixed die 622. To the axial center of the fixed die 622, there is provided a fixation hole 623 for allowing the insertion of the shaft member 602. The movable die 621 has a molding surface 621a for molding the upper end surface 610a2 of the disk portion 610a of the hub 610, and gates 624 provided in the molding surface 621a. The gates 624 are dotted gates equiangularly provided at three portions, and are provided at each of the positions where the rotation stopping holes 610a20 formed later are to be formed, that is, at predetermined positions on the molding surface 621a. Via the gates 624, the molten resin is injected into a cavity 625 defined by the movable die 621 and the fixed die 622.

After the molten resin filled in the cavity 625 is hardened, the molding die is opened so that the hub 610 molded integrally with the shaft member 602 is taken out (refer to FIG. 47(b)). In accordance with the mold opening, gate hardening portions formed in the gates 624 are automatically cut (alternatively, the gate hardended portions are cut by a gate cutting mechanism), with the result that parts of the gate hardening portion are left as gate marks 624a at gate corresponding positions of the hub 610.

The gate marks 624a are removed by machine working, and the rotation stopping holes 610a20 are formed simultaneously with the removing process of the gate marks 624a. Specifically, as illustrated in FIG. 47(c), for example, an end mill 626 attached to a milling machine (not shown) is rotated, and is lowered in that state so as to grind predetermined positions on the upper end surface 610a2 of the disk portion 610a of the hub 610, thereby removing the gate marks 624a. After that, when the end mill 626 is further lowered and is brought into contact with the core metal 613, or immediately before being brought into contact therewith, the lowering of the end mill 626 is stopped. As a result, the axial rotation stopping holes 610a20 are formed in the resin molding portion 614. As described above, the removing process of the gate marks and the formation of the rotation stopping holes 610a20 are performed in the same process, whereby the number of processes is reduced, and the formation of the hub 610 is simplified. Note that, the rotation stopping holes 610a20 are not necessarily be caused to pass through the resin molding portion 614 as in FIG. 43 as long as having a depth for performing a function as a rotation stopper at the time of mouning the clamper.

Note that, in the fixed die 622, a molding surface 622a for molding the second tapered surface 610b1 on the inner peripheral surface of the cylindrical portion 610b of the hub 610 has a so-called undercut shape in which the radius thereof is decreased in the demolding direction of the molded product. Therefore, when the molded product is demolded after the hardening of the resin, there is a risk that the second tapered surface 610b1 of the hub 610 and the molding surface 622a of the fixed die 622 are interfered with each other so that the second tapered surface 610b1 is damaged. However, the degree of the taper angle of the second tapered surface 610b1 is minute, and hence the interference between the second tapered surface 610b1 and the molding surface 622a is extremely small. Accordingly, even when the hub 610 is forcibly pulled and demolded, the second tapered surface 610b1 is not damaged owing to the slipping property and elasticity of a resin material.

As described above, in this embodiment, the rotation stopping holes 610a20 formed in the hub 610 are formed by the removing process of the gate marks 624a after the molding of the hub 610. Accordingly, it is unnecessary to provide molding portions for forming the rotation stopping holes in the molding die of the hub 610, and hence it is possible to secure the fluidity of the molten resin injected into the cavity. With this configuration, as illustrated in FIG. 47(a), even when the core metal 613 is arranged in the cavity 625, the resin is reliably filled to the end portion of the cavity 625. Thus, the hub 610 can be molded with high dimensional accuracy. Accordingly, the fixation strength between the hub 610 and the shaft member 602 is increased, and the adherence of the boundary surface therebetween also can be enhanced. As a result, it is possible to reliably prevent the failure such as oil leakage from the boundary surface. Further, it is possible to prevent the formation of the weld line caused by the molten resin flowing around the molding portion, and hence it is possible to enhance the strength and durability of the hub 610.

The present invention is not limited to the above-mentioned embodiment. Other embodiments of the present invention are described in the following. Note that, in the following description, the parts having the same structures and functions as those in above-mentioned embodiment are denoted by the same reference symbols, and description thereof is omitted.

In the above-mentioned embodiment, while the shaft member 602 is prevented from being detached by the flange portion 602b provided at the lower end of the shaft member 602, this should not construed restrictively. For example, in the fluid dynamic bearing device 601 illustrated in FIG. 48, a detachment stopping member 615 is fixed along the inner periphery of the hub 610, and the detachment stopping member 615 and the housing are engaged with each other in the axial direction. In this manner, the shaft member 602 and the hub 610 are prevented from being detached. The detachment stopping member 615 is formed, for example, in a substantially L-shaped cross-section by press working of a metal material, and is fixed to a step portion 610e provided at the upper end of the inner peripheral surface of the cylindrical portion 610b of the hub 610. The seal space S is formed between an inner peripheral surface 615a of the detachment stopping member 615 and the first tapered surface 309b in the upper portion of the outer peripheral surface of the housing 609 opposed thereto. The inner peripheral surface 615a is formed in a tapered shape gradually enlarged upward, and has the same function as that of the second tapered surface 610b1 of the above-mentioned embodiment.

In the fluid dynamic bearing device 601, a thrust bearing portion is provided only at one point. Specifically, the thrust bearing portion T is provided between the lower end surface 610a1 of the disk portion 610a of the hub 610 and the upper end surface 609a of the housing 609. The housing 609 is formed in a cup shape, and an inner bottom surface 609f thereof is provided with a radial groove 609f1. Through an intermediation of the radial groove 609f1 and the axial groove 608d1 provided in the outer peripheral surface 608d of the bearing sleeve 608, a gap between a lower end surface 602c of the shaft member 602 and the inner bottom surface 609f of the housing 609 and a gap between the lower end surface 610a1 of the disk portion 610a of the hub 610 and the upper end surface 608c of the bearing sleeve 608 are communicated with each other. Note that, in the fluid dynamic bearing device 601 illustrated in FIG. 48, the illustration of the disk D, the clamper 603, and the screw 607 are omitted.

In the above-mentioned embodiment, while the case where the hub 610 is formed of a resin which is injection-molded together with a metal portion inserted thereto, this should not construed restrictively. The whole of the hub 610 may be formed by injection molding of a resin. In this case, the rotation stopping holes 610a20 are formed to have a depth insufficient to pass through the hub 610.

In the first to sixth embodiments described above, the structure is illustrated in which the dynamic pressure grooves of a herringbone configuration or a spiral configuration constitute the radial bearing portions R1 and R2 and the thrust bearing portions T1 and T2 (alternatively, thrust bearing portion T as abbreviated in the following) so as to generate the dynamic pressure effect of the lubricating oil. However, the present invention is not limited thereto.

For example, as the radial bearing portions R1 and R2, there may be adopted a so-called dynamic pressure generating portion of a stepped configuration in which axial grooves (not shown) are formed at multiple portions in a circumferential direction, or a multi-arc bearing in which multiple arc surfaces are arranged in the circumferential direction so as to form, together with the perfectly circular outer peripheral surface 2a of the shaft member opposed thereto, a wedge-like radial gap (bearing gap) therebetween.

Alternatively, a so-called cylindrical bearing can be constituted by the inner peripheral surface 8a of the bearing sleeve 8 which is formed as a perfectly circular outer peripheral surface in which, as a dynamic pressure generating portion, the dynamic pressure grooves, the arc surfaces, or the like are not provided, and the perfectly circular outer peripheral surface 2a of the shaft member 2 opposed to the inner peripheral surface 8a.

Further, in the above-mentioned embodiment, while the radial bearing portions R1 and R2 are formed separately in the axial direction, this should not be construed restrictively. The radial bearing portions R1 and R2 may be continuously formed in the axial direction. Alternatively, only any one of the radial bearing portions R1 and R2 may be formed.

Further, while not shown as well, one or both the first thrust bearing portion T1 and the second thrust bearing portion T2 are constituted by a so-called step bearing or a wave bearing (in which the wave shape is substituted for the step configuration), in which multiple dynamic pressure grooves of a radial groove configuration are provided at predetermined intervals in a circumferential direction in a region where the dynamic pressure generating portion is formed (lower end surface 8b of bearing sleeve 8 and upper end surface 9a of housing 9, for example).

Further, in the above-mentioned embodiments, the case is illustrated where the radial dynamic pressure generating portion (dynamic pressure grooves 8a1 and 8a2) and the thrust dynamic pressure generating portion (dynamic pressure grooves 8b1 and 9a1) are formed on the side of the bearing sleeve 8 and the side of the bearing sleeve 8 and housing 9, respectively. The region where those dynamic pressure generating portions are formed can be formed in the shaft member 2 and the flange portion opposed thereto or on the side of the hub 10.

Further, in the above description, the lubricating oil is illustrated as a fluid filled inside the fluid dynamic bearing device 1 so as to generate the dynamic pressure effect in the radial bearing gap and the thrust bearing gap. Otherwise, it is possible to use a fluid capable of generating dynamic pressure in the bearing gaps, such as gas including air, a magnetic fluid, or a lubricating grease.

Further, in the above-mentioned embodiments, the disk is placed onto the hub and the fluid dynamic bearing device is used in a spindle motor which is used for a disk drive such as an HDD. However, this should not construed restrictively. For example, a polygon mirror is mounted to the hub so that the fluid dynamic bearing device can be used for supporting the rotational axis of a polygon scanner motor of a laser beam printer. Alternatively, a color wheel is mounted to the hub so that the fluid dynamic bearing device can be used for supporting the rotational axis of the color wheel of a projector. Alternatively, a fun is attached to (integrated with) the hub so that the fluid dynamic bearing device can be used as a fan motor.

Note that, the embodiments of the present invention are not limited to the above. The above-mentioned structures of the fluid dynamic bearing device according to the first to sixth embodiments of the present invention may be appropriately combined with each other.

### BRIEF DESCRIPTION OF THE DRAWINGS

FIG. 1 is a sectional view of a spindle motor incorporating a fluid dynamic bearing device 1.

FIG. 2 is a sectional view of the fluid dynamic bearing device 1.

FIG. 3 is a sectional view of a bearing sleeve.

FIG. 4 is a bottom view of the bearing sleeve.

FIG. 5 is a top view of a housing.

FIG. 6 is a sectional view illustrating an injection molding process of a hub.

FIG. 7 is a sectional view illustrating another example of the fluid dynamic bearing device.

FIG. 8 is a sectional view illustrating still another example of the fluid dynamic bearing device.

FIG. 9 is a sectional view illustrating an injection molding process of a conventional hub.

FIG. 10 is an enlarged sectional view illustrating a vicinity of a boundary surface between the conventional hub and a shaft member.

FIG. 11 is a sectional view of a spindle motor incorporating a fluid dynamic bearing device 201.

FIG. 12 is a sectional view of the fluid dynamic bearing device 201.

FIG. 13 is a sectional view of a bearing sleeve.

FIG. 14 is a top view of a housing.

FIG. 15 is a front view illustrating a working process of the shaft member.

FIG. 16 is a front view illustrating another example of a concave-convex portion of the shaft member.

FIG. 17 is a sectional view illustrating another example of the fluid dynamic bearing device 201.

FIG. 18 is a sectional view of a spindle motor incorporating a fluid dynamic bearing device 301.

FIG. 19 are sectional views of the fluid dynamic bearing device 301 of the present invention.

FIG. 20 is an axial sectional view of a bearing sleeve.

FIG. 21 is a top view of the bearing sleeve.

FIG. 22 is a top view of a housing.

FIG. 23 is a sectional view illustrating a vicinity of a minute gap C of another example of the fluid dynamic bearing device.

FIG. 24(a) is a sectional view illustrating the vicinity of the minute gap C of still another example of the fluid dynamic bearing device, and FIG. 24(b) is a top view of a bearing sleeve of the fluid dynamic bearing device.

FIG. 25 is a top view illustrating another example of the bearing sleeve.

FIG. 26 is a sectional view illustrating the vicinity of the minute gap C of yet another example of the fluid dynamic bearing device.

FIG. 27 is a sectional view illustrating a fluiddynamic bearing device 321 of another example.

FIG. 28 is a sectional view of a spindle motor incorporating a fluid dynamic bearing device 401.

FIG. 29 are sectional views of the fluid dynamic bearing device 401.

FIG. 30 is a sectional view of a bearing sleeve.

FIG. 31 is a bottom view of the bearing sleeve.

FIG. 32 is a top view of a housing.

FIG. 33 is a sectional view of a fluid dynamic bearing device 421 of another example.

FIG. 34 is a sectional view of a spindle motor incorporating a fluid dynamic bearing device 501.

FIG. 35 is a sectional view of the fluid dynamic bearing device 501.

FIG. 36 is a sectional view of a bearing sleeve.

FIG. 37 is a bottom view of the bearing sleeve.

FIG. 38 is a top view of a housing.

FIG. 39 is a plan view of a shaft member and a core metal.

FIG. 40 is a plan view of a shaft member and a core metal of another example.

FIG. 41 is a sectional view of a fluid dynamic bearing device 521 of another example.

FIG. 42 is a sectional view of a spindle motor incorporating a fluid dynamic bearing device 601.

FIG. 43 is a sectional view of the fluid dynamic bearing device 601.

FIG. 44 is a sectional view of a bearing sleeve.

FIG. 45 is a bottom view of a bearing sleeve.

FIG. 46 is a top view of a housing.

FIG. 47 are sectional views illustrating injection molding processes of a hub.

FIG. 48 is a sectional view of the fluid dynamic bearing device 601 of another example.

FIG. 49(a) is a sectional view illustrating an injection molding process of a conventional disk hub, and FIG. 49(b) is an enlarged plan view thereof.

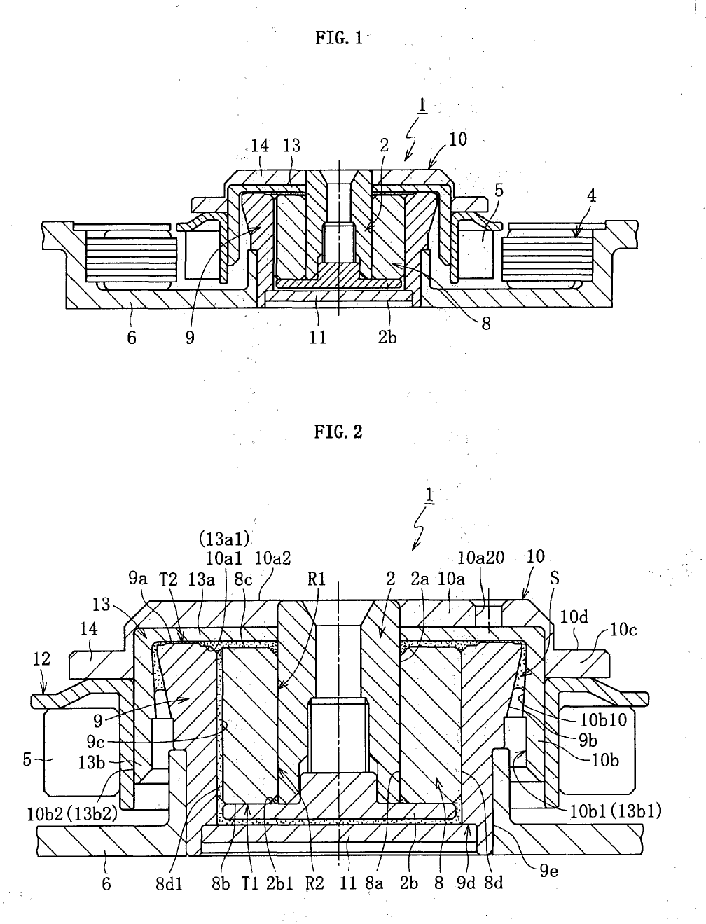

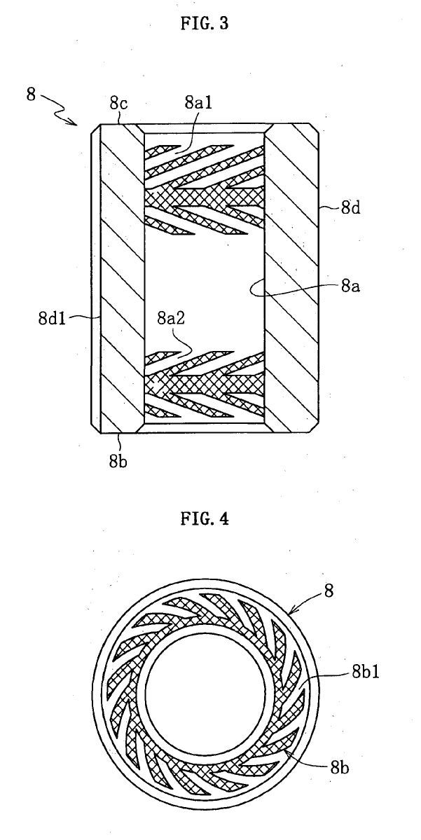

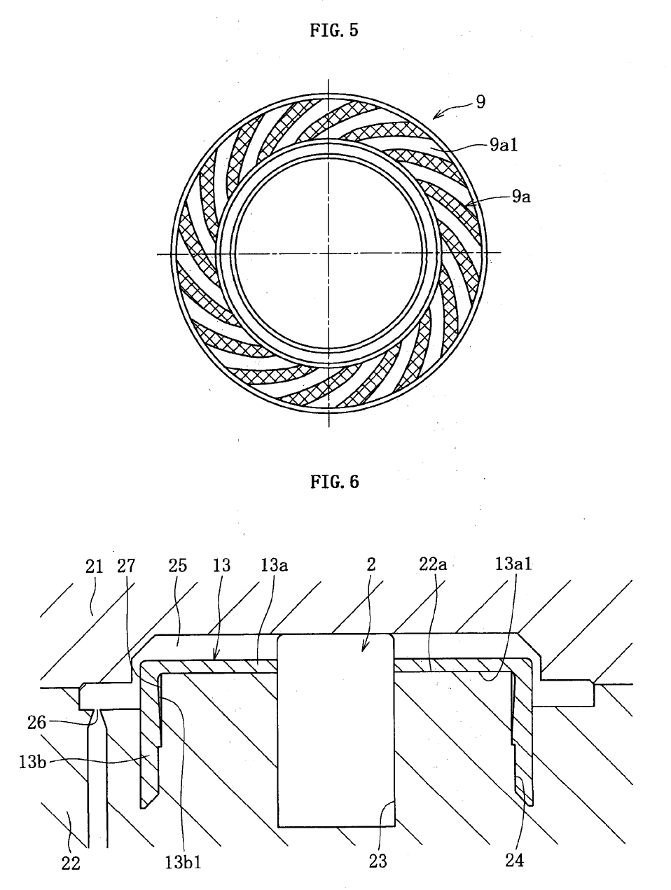

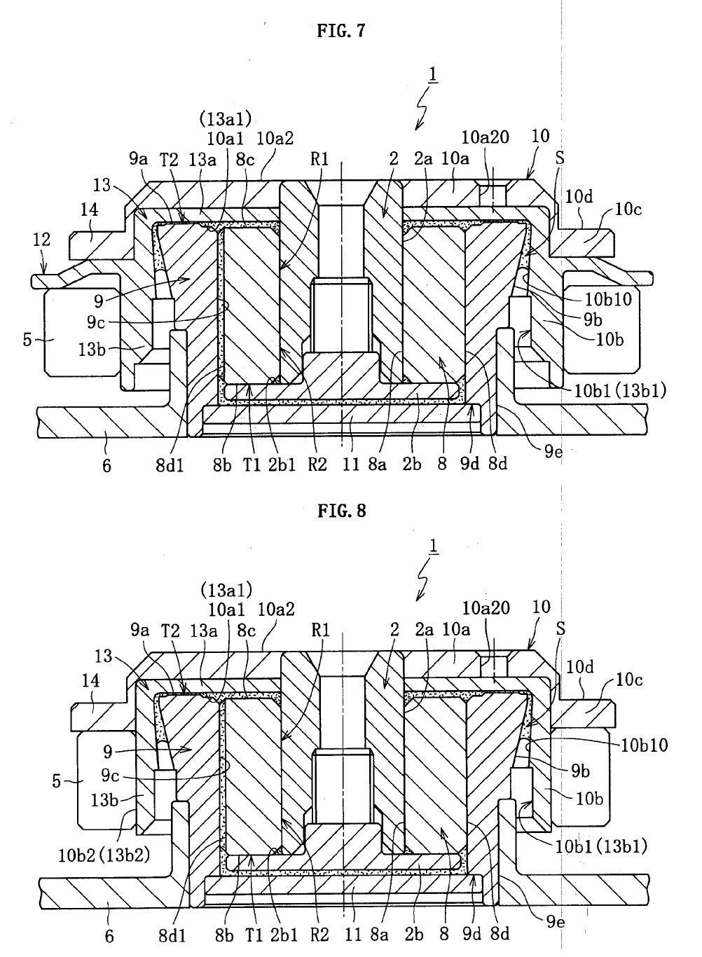

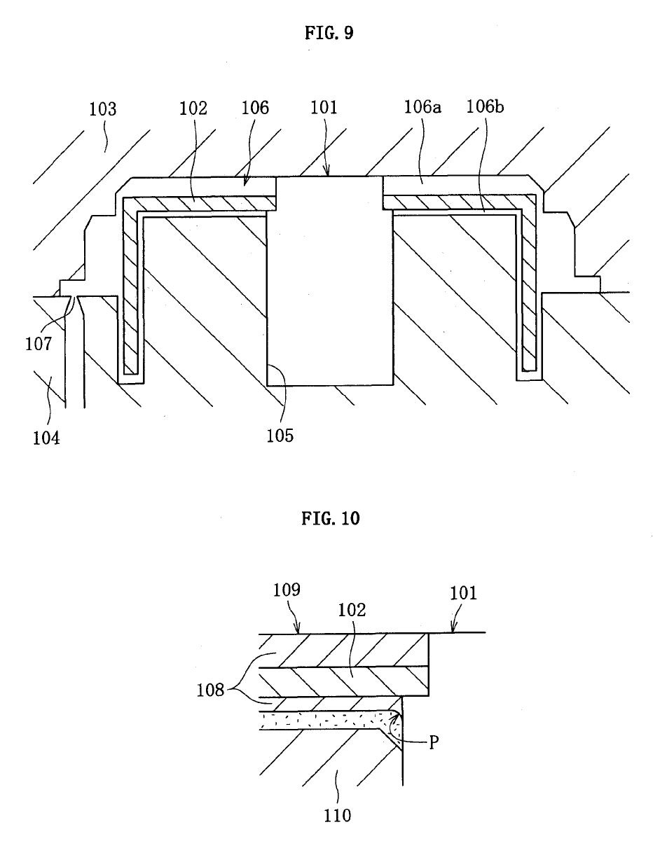

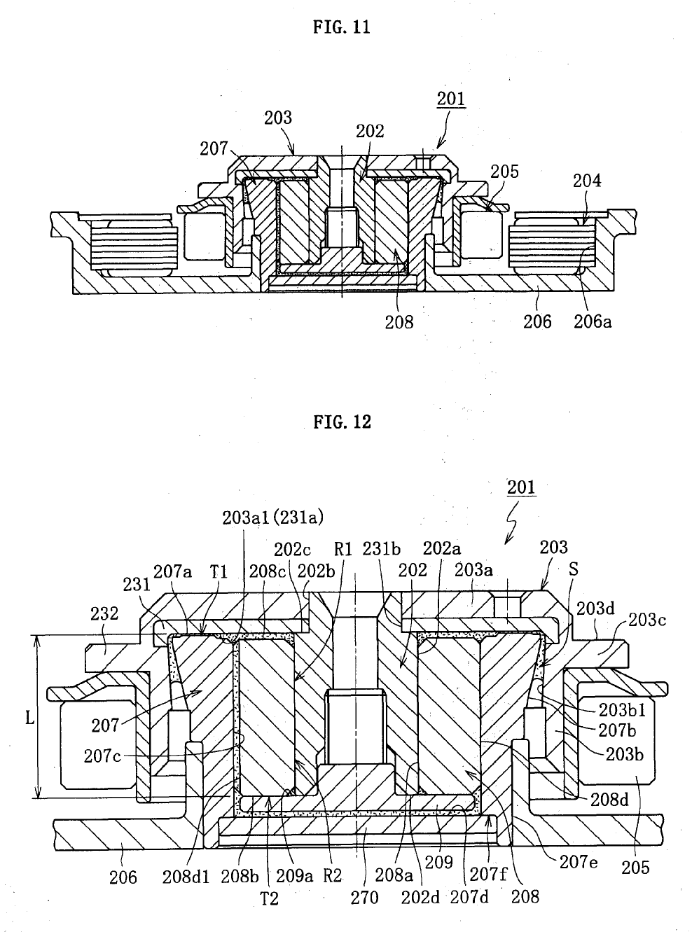

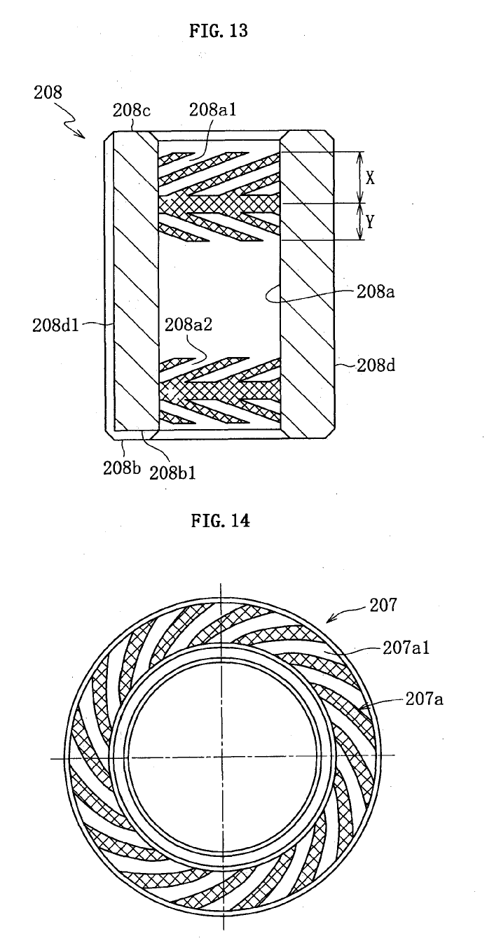

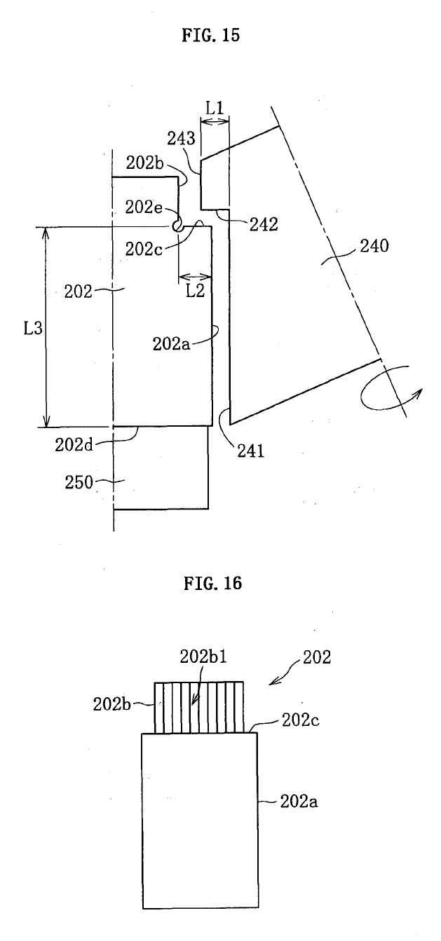

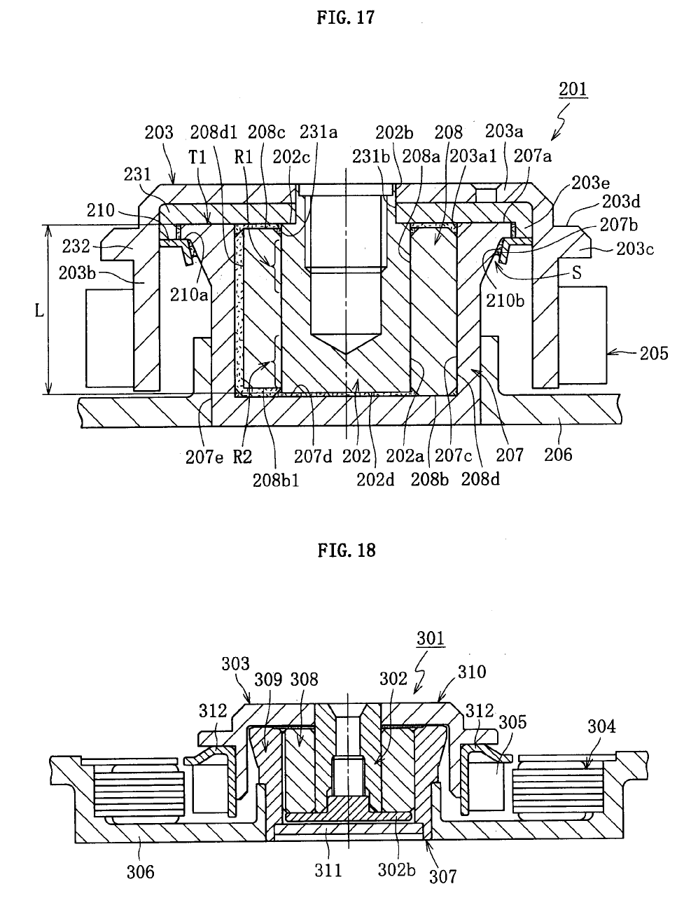

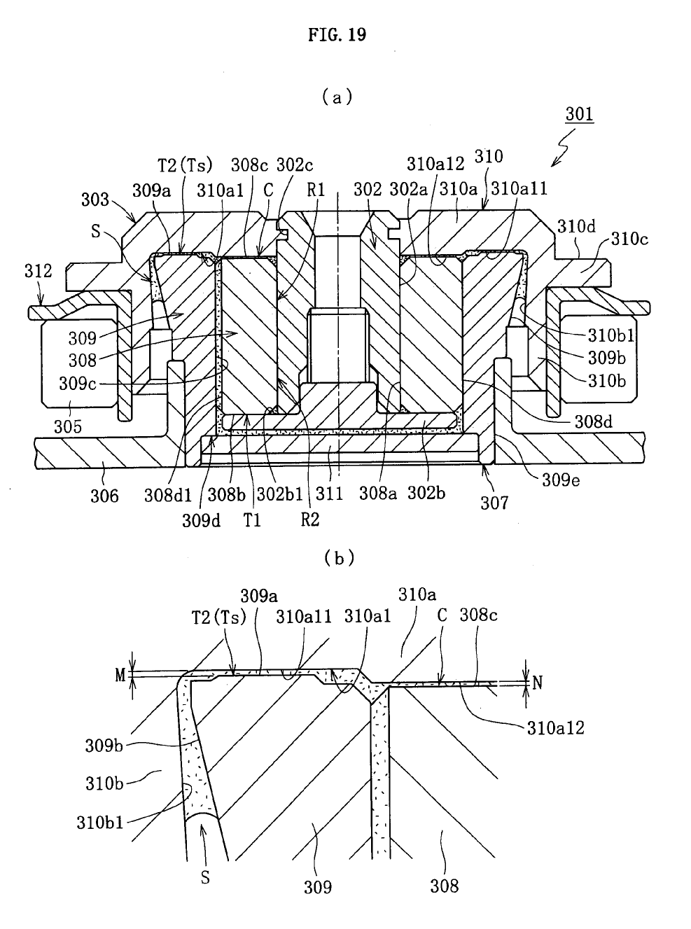

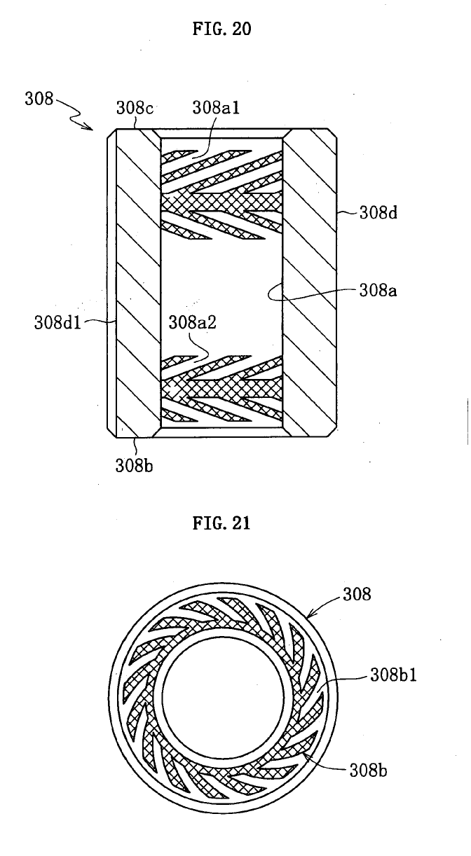

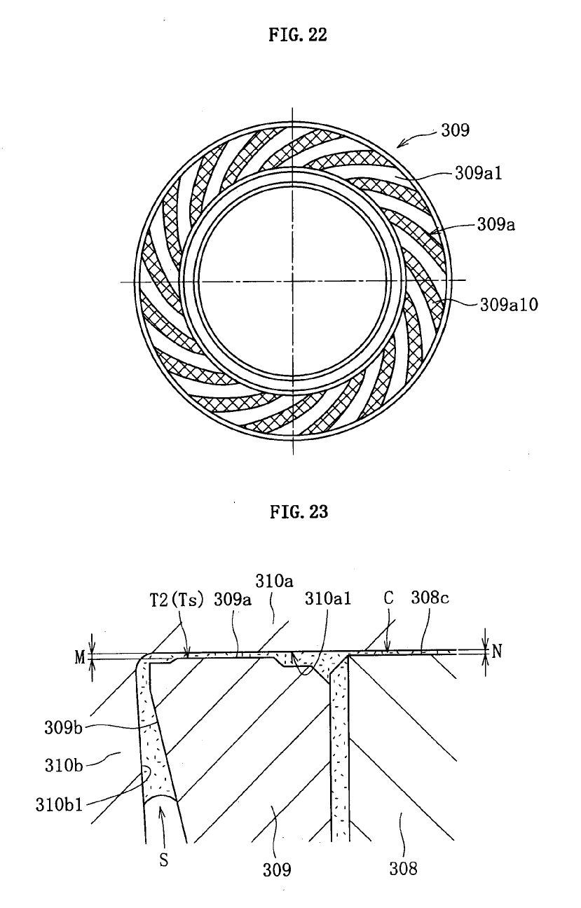

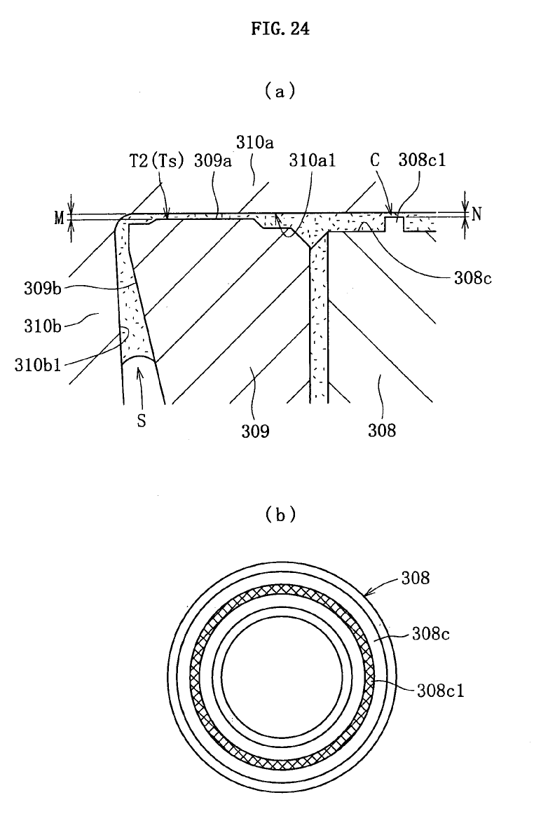

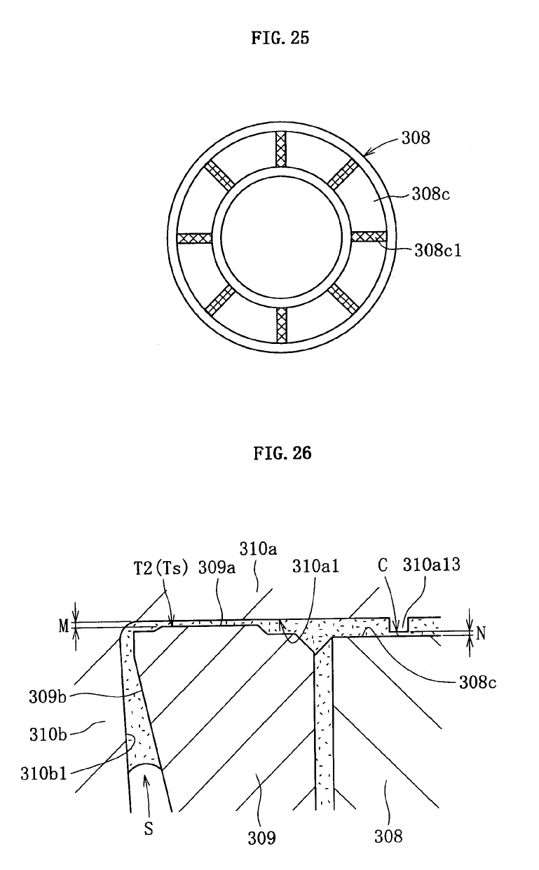

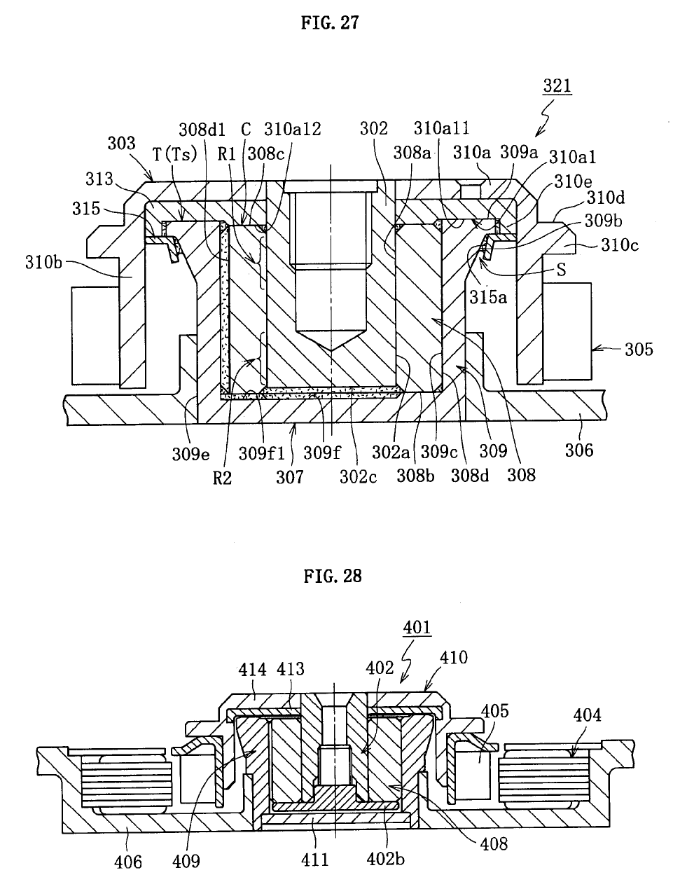

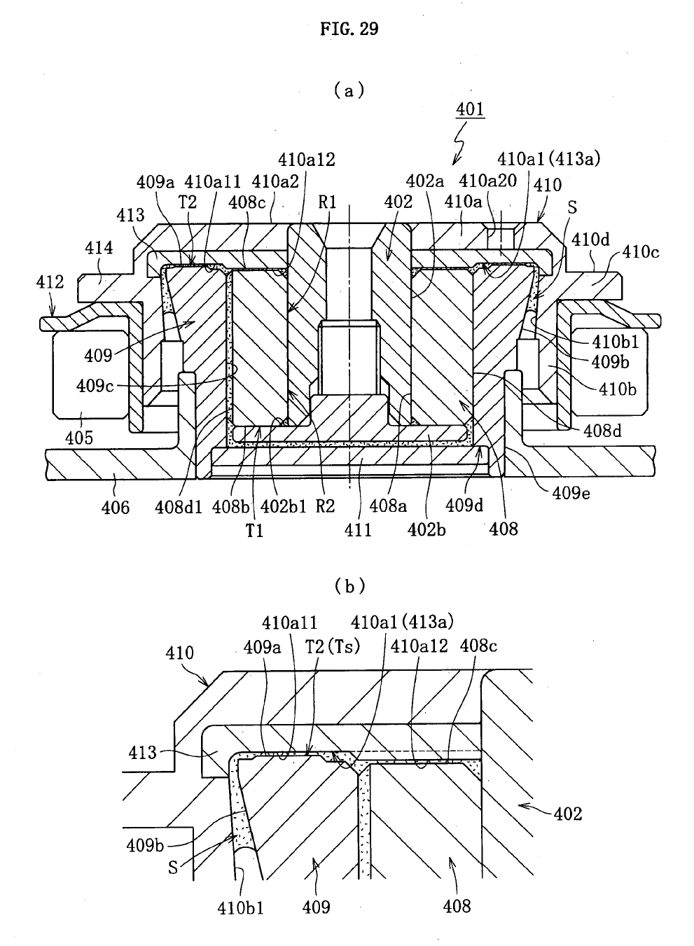

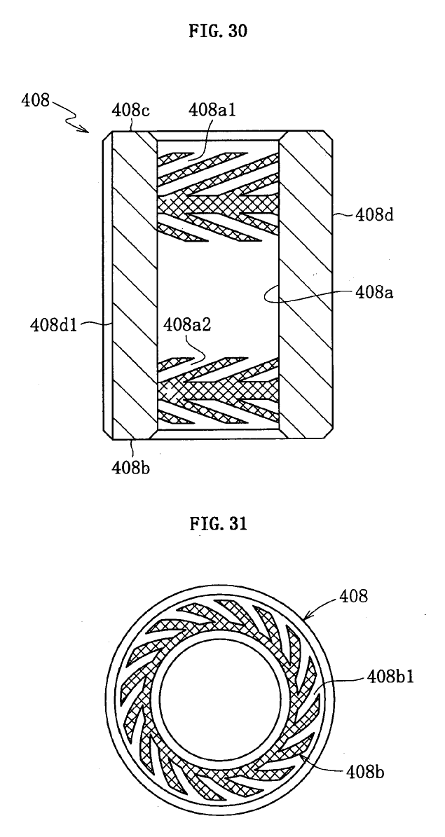

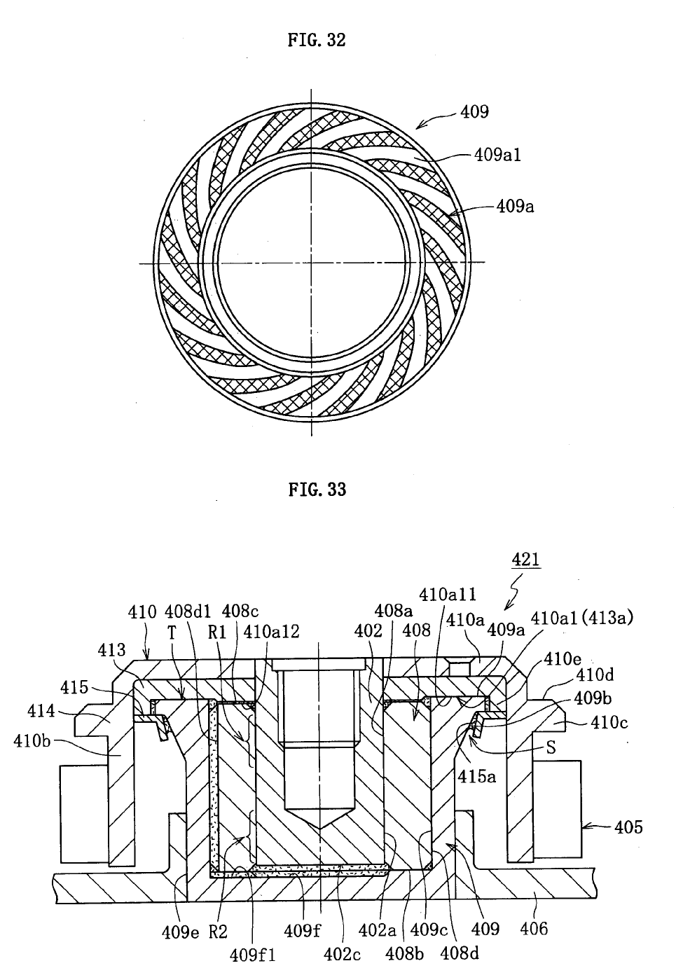

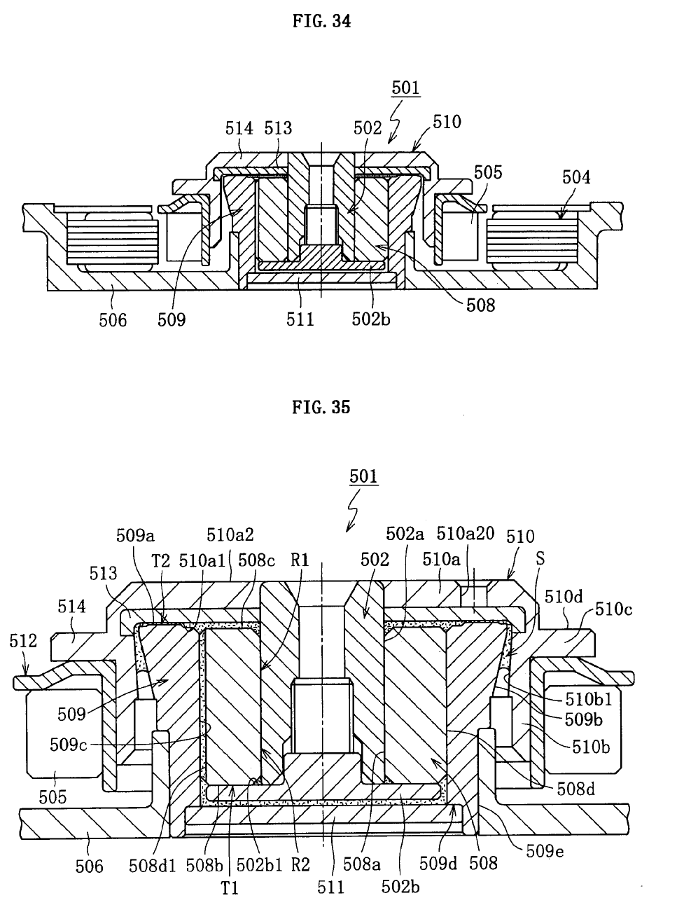

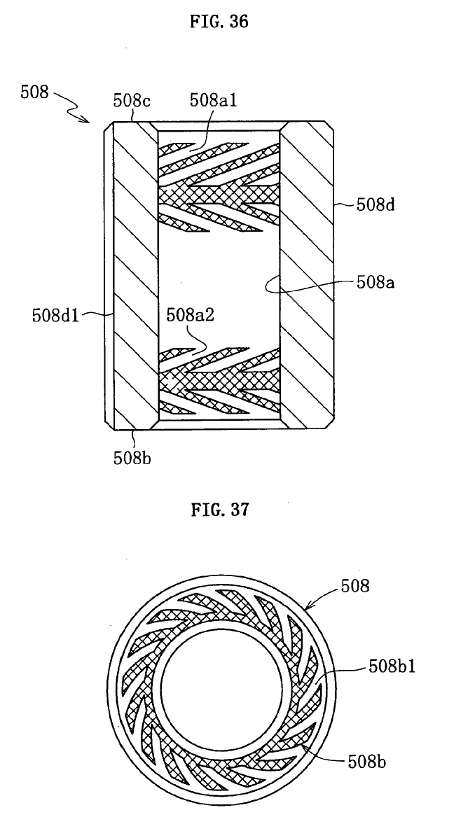

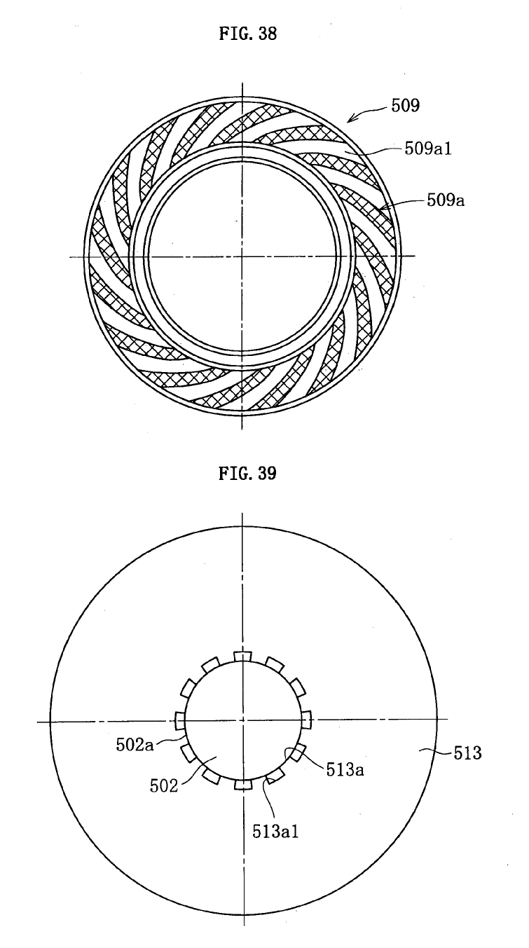

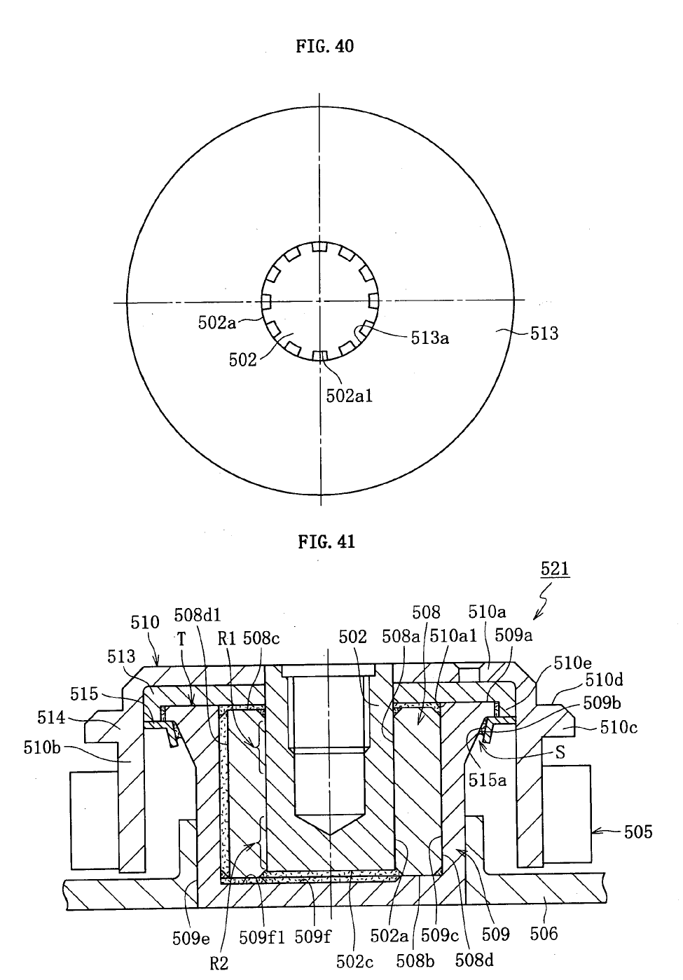

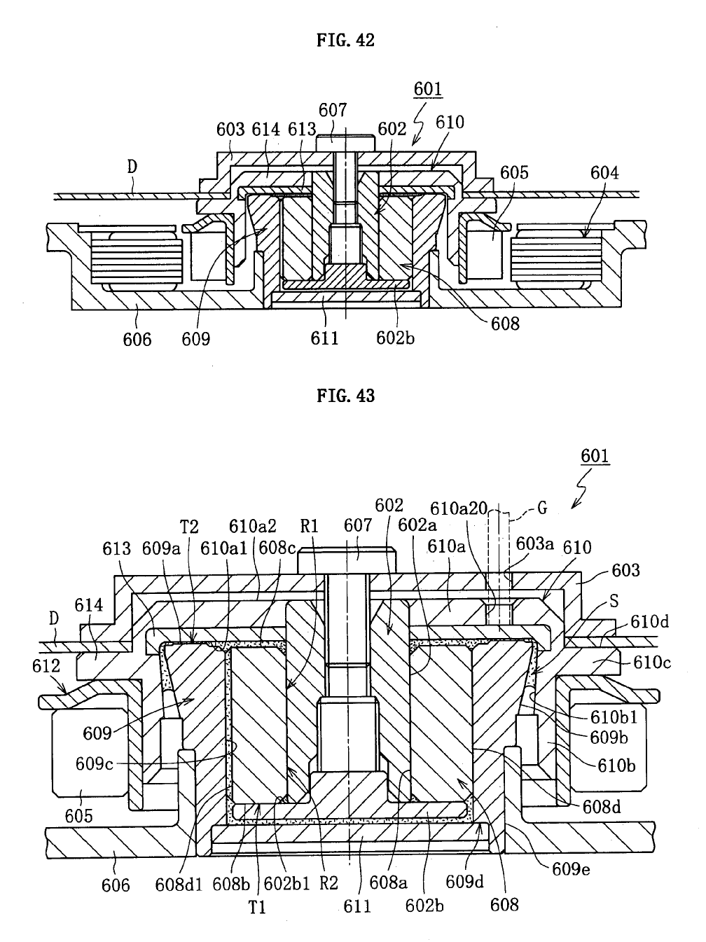

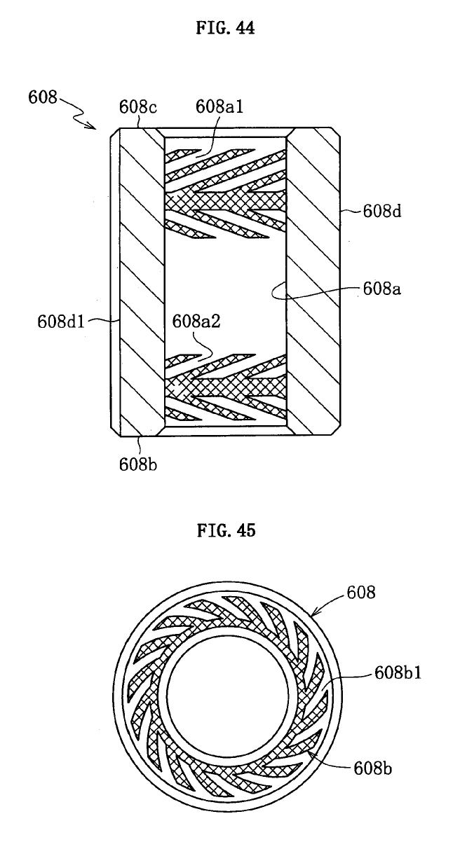

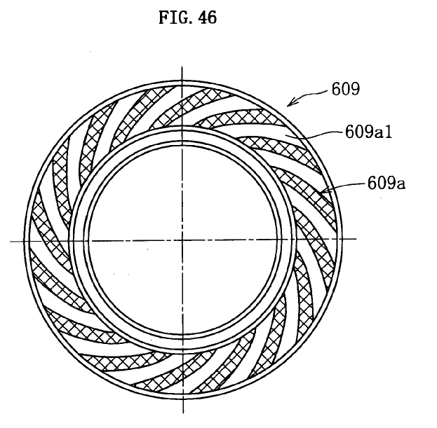

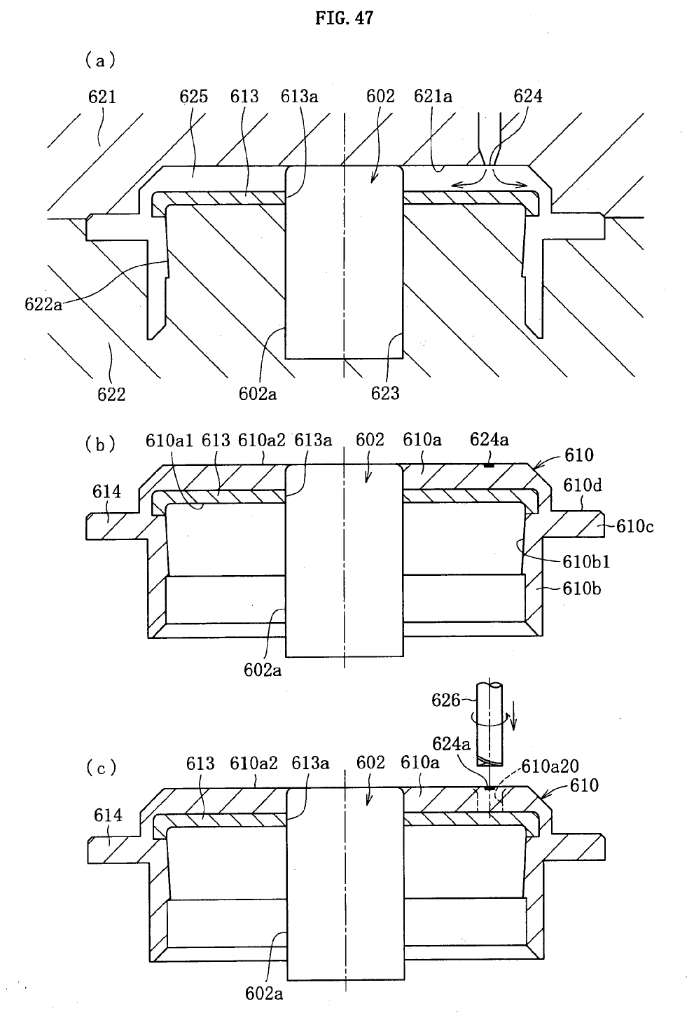

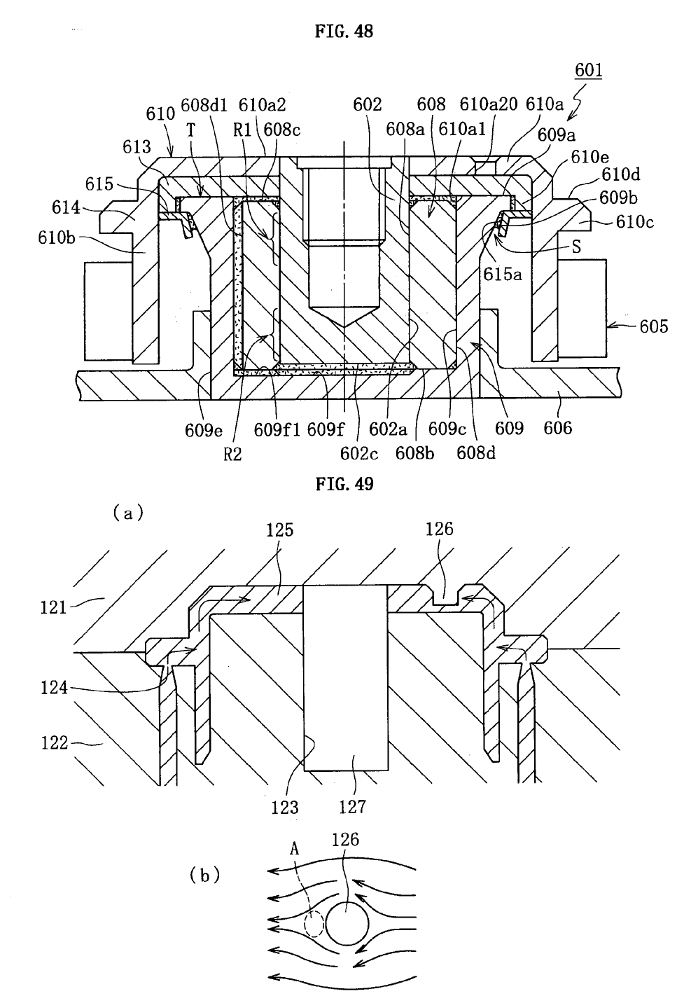

### DESCRIPTION OF REFERENCE SYMBOLS

1 fluid dynamic bearing device

2 shaft member

4 stator coil

5 rotor magnet

6 bracket

8 bearing sleeve

9 housing

10 hub

13 core metal

14 resin portion

11 lid member

12 yoke

21 fixed die

22 movable die

25 cavity

26 gate

27 cylindrical surface

R1, R2 radial bearing portion

T1, T2 thrust bearing portion

S seal space

1. A fluid dynamic bearing device, comprising:
a shaft member;
a hub protruding in a radially outward direction with respect to the shaft member and attached with a rotor magnet;
a radial bearing gap faced with an outer peripheral surface of the shaft member; and
a thrust bearing gap faced with an end surface of the hub, the shaft member being supported by a lubricating film generated in the radial bearing gap and the thrust bearing gap,
wherein the hub is a product formed by injection molding of a resin together with a core metal inserted thereto, the core metal being exposed on a surface of the hub.

2. A fluid dynamic bearing device according to claim 1, wherein a portion of the hub, which is faced with an internal space being filled with lubricant, is formed of the core metal.

3. A fluid dynamic bearing device according to claim 1, further comprising a seal space for preventing lubricant from leaking out,
wherein an outer peripheral portion of the seal space is constituted by a tapered surface having an undercut shape, the tapered surface being formed on an inner peripheral surface of the hub and formed of the core metal.

4. A fluid dynamic bearing device according to claim 1, wherein a yoke is bonded to be fixed to the core metal.

5. A fluid dynamic bearing device according to claim 1, wherein the core metal and a yoke are integrally formed with each other.

6. A fluid dynamic bearing device according to claim 1, wherein:
the shaft member is formed in a shape of stepped shaft and has a shoulder surface;
an end surface of the core metal engaged along the outer peripheral surface of the shaft member is brought into contact with the shoulder surface of the shaft member; and
the thrust bearing gap is formed by the end surface of the core metal.

7. A fluid dynamic bearing device according to claim 6, wherein a concave-convex portion is provided in a region of the outer peripheral surface of the shaft member, the region being held in contact with the hub.

8. A fluid dynamic bearing device according to claim 6, wherein the shoulder surface of the shaft member is formed as a grinded surface.

9. A fluid dynamic bearing device according to claim 8, wherein grinding of the shoulder surface of the shaft member is performed with reference to one end surface of the shaft member.

10. A fluid dynamic bearing device according to claim 8, wherein, of the shaft member, the shoulder surface and the outer peripheral surface which forms the radial bearing gap are simultaneously grinded.
